(19) United States
(12) Patent Application Publication
(10) Pub. No.: US 2023/0013678 A1
(43) Pub. Date: Jan. 19, 2023

(54) A THERMALLY CONTROLLED HOUSING ASSEMBLY FOR ELECTRICAL CELLS

(71) Applicant: HUTCHINSON, PARIS (FR)

(72) Inventors: Fabrice CHOPARD, SAINT MARTIN D'HERES (FR); Bertrand FLORENTZ, PAUCOURT (FR)

(21) Appl. No.: 17/618,794

(22) PCT Filed: Jun. 11, 2020
(86) PCT No.: PCT/FR2020/050997

§ 371 Date: May 2, 2022

(30) Foreign Application Priority Data
Jun. 11, 2019 (FR) FR1906209

(51) Int. Cl. H01M 10/6555; H01M 10/625; H01M 10/6557; H01M 10/6567

(52) U.S. Cl. CPC H01M 10/6555; H01M 10/625; H01M 10/6557; H01M 10/6567; H01M 2220/20

(57) ABSTRACT

An assembly comprising a housing (6) having walls (11) and containing groups of electrical cells (7). Each wall contains at least one space in which, at a given time, a flow of thermal fluid (F2) can be present.

The said space, and thus the corresponding wall (11), has a flow of fluid inlet and outlet. In a flow of fluid-tight manner, the flow of fluid inlet and outlet communicate with, respectively, a supply (25a) of thermal flow of fluid and a discharge (25b) of said flow of fluid, so that the flow of fluid can circulate in said space. Through the surrounding wall and said sealed communications, said space is physically isolated from the cells, so that the flow of fluid (F2) therein and the interior space (9) of the housing do not communicate. The wall (11) extends parallel to at least one of the lateral faces of at least one said cell (7).

### TECHNICAL FIELD OF THE INVENTION

The technical field of the invention is that of the thermal management of the cells of an electric battery intended to deliver electrical energy, particularly in a vehicle, in particular a hybrid or “all-electric” vehicle, in which at least one electric motor is present, whether or not coupled to at least one combustion engine.

Large electric batteries, for example on ships or in the railway sector, which need to be thermally managed, are also concerned.

The term “vehicle” is to be understood in a broad sense.

### PRIOR ART

Thermally managing the cells of an electric battery is a problem.

The cells are adapted to operate in a preferred temperature range.

Otherwise, they are less efficient: reduced life span, reduced electrical performance.

It has already been proposed to manage their operating temperature.

Thus, it has been proposed, for example for an electric or hybrid motor vehicle provided with an electric motor connected to a battery whose cells are erected vertically and parallel to one another, to circulate a flow of fluid under the cells (thus on a single lower side or face of these cells considered together), this flow of fluid coming into thermal exchange with the said cells, in operation.

It is conceivable that this way of thermally managing the cells may have been dictated:
by a difficulty in assessing the question of this thermal management independently of the rest of the vehicle, and in particular its immediate environment; it is currently considered a priori that the battery and its thermal management must adapt to the constraints of the vehicle (available space, orientation in space, connection to the power supply in terms of the flow of fluid to be circulated under the cells), and not the reverse by a lack of detailed consideration of the issue of thermal management itself: this is complex; hence the need to try to ensure that its environment adapts to it, and not excessively the other way round,
by a hitherto inadequate industrial approach to a solution that can be produced in series, for several types of battery or cells, without there being an almost indissociable vehicle/battery/cell thermal management system from the start.

Although not just rolling vehicles are concerned by the problem of the invention, by way of more precise example we can cite a solution for thermal management of cells of an electric battery which provides for the presence of a “cooling plate” under the battery in which a flow of “thermal” fluid circulates, in thermal exchange with the cells of this battery.

It is specified:
that “cell” here means electrochemical cell and more generally electrical cell (which generates electricity), and
that “thermal flow of fluid” here means an adapted flow of fluid:
   to supply heat to the cells, to heat them if they are at a temperature below a so-called “first temperature range” corresponding to the nominal (operating) state of these cells,
   to evacuate heat from the cells, to cool them if they are at a temperature above this “first temperature range”, and are then in an overheated or “abnormal (operating) state” as a result of thermal runaway conditions.

The “thermal flow of fluid” could be described as a heat carrier in that it transports (brings to the cells) or removes (from the cells) heat.

Several reasons may have converged for the above positioning under the cells: safety in case of leakage, space and maintenance.

Each solution involves communication with the BMS (Battery Management System) which is the electronic control system at the interface between the vehicle supervisor (energy management, actuator control) and the battery pack (which contains all the cells).

In any case, problems in the thermal management of the cells remain, including: insufficient thermal efficiency,
new requirements in terms of space, especially in height, in a cramped environment, and/or in terms of mechanical protection of the thermal management means adjacent to the electric battery,
cost of current solutions.

For example, it is currently typically difficult to deal with hot spots on the top of the cells due to the electrical terminals.

The cell/cooling plate exchange areas remain relatively small.

However, and especially in the future, increasingly frequent situations of fast charging (time of less than 15 minutes) can lead to the need to dissipate a thermal power of, for example, 20 kW in the battery compartment (2 kW in nominal use). This heat will raise the temperature of the whole battery pack to a level above (e.g. threshold at 35° C. for Li-Ion cells) the nominal temperature range (e.g. between 20° C. and below 35° C. for Li-Ion cells) in which pack operation is desired. Devices such as PCM (phase change material) charged elements could help to dampen this temperature increase by 3 to 10° C. However, at the end of a fast recharge, a more efficient cooling system for the modules becomes a necessity.

Typically, a lower temperature for the flow of fluid coming in thermal exchange with the cells (here called “heat transfer flow of fluid” or “thermal flow of fluid”) would imply a modification of the cooling setpoints, a loss of efficiency on the cold producing means and an increase of the flow rate (probably need for a variable flow pump, with then a higher power consumption) or an increase of the exchange surface at the level of the thermal management of the cells. There are also problems of temperature homogeneity within the cells.

### Disclosure of the Invention

The invention aims to improve the above situation by addressing at least some of the problems mentioned. It is an improvement in the thermal management of the electrical cell(s) that is expected. An increase in the electrical efficiency of the cell(s) and/or an increased lifetime is also targeted.

### SUMMARY OF THE INVENTION

To this end, it is proposed in particular an assembly comprising:
at least one cell of an electric battery or a module having several sides and containing a group of cells, said at least one cell or the module having several sides, and
at least one wall adapted to be in thermal exchange with said at least one cell and disposed for this purpose opposite it, in a plane parallel to one of the sides of said at least one cell or the module, said at least one wall enclosing at least one space in which at least one flow of fluid (F1, F2 hereinafter referred to as the “flow of fluid”), adapted to be in heat exchange with the at least one cell or the module, can be present for its thermal management, This assembly being characterised in that the at least one space comprises at least one first space and at least one second space:
which extend in two planes parallel to each other and to said side of said at least one cell or module facing which (to which) said wall extends (as discussed below these two parallel planes can be combined plans),
which are separated by at least one partition, so as not to communicate with each other, and
which are adapted so that there are present, as said at least one flow of fluid and at the same time or at different times of operation of said at least one cell or of the module, respectively a first flow of fluid (F2) and a second flow of fluid (F1) not mixing.

When placed in front of at least one of the said cells or module, the aforementioned wall and this cell (or even the other cells which will be aligned with this first cell, in the same plane) will be adjacent, i.e. immediately close to each other.

In this way, it will be possible to have two flows of fluid(s), to be used at the appropriate times and in an optimised geometry.

In this context, it is also proposed that the said at least one wall should be made of a material such that it does not contain PCM, the use of which can be reserved elsewhere.

The aforementioned assembly can even be such that the at least one first space and the at least one second space, which define respective hollow interiors in the at least one wall, are each so large that they will occupy most at least of the interior of the at least one wall, to adapt the temperature thereof.

It will then be allowed that the thermal exchange fluid(s) flows are not limited to circulating in small tubes passing just under the cells, as in the existing “cooling plates”.

Another point to consider can be the extent of the thermal exchange zones between the fluid(s) and the cell(s).

Consequently, the following is proposed:
that said at least one wall has a perimeter along an elongated thin edge,
that said at least one wall extends in a plane perpendicular to said thin edge and along which the wall has a surface (S) delimited by said perimeter,
and that said at least one first space and said at least one second space each occupy more than 50% of said surface (S).

This combines the possibility of manufacturing fine structures and series with particularly large exchange surfaces.

As a first possibility for optimised manufacturing, it is proposed that:
said at least one first space and at least one second space can be defined respectively between a first plate and a second plate and between the second plate and a third plate which are parallel to each other and joined together, or
that, in order to define said first and second spaces, the first, second and third plates are provided with peripheral flanges arranged to direct said flows.

As a second optimised manufacturing possibility, it is proposed that at least one of said first and second spaces is defined by a series of tubes arranged in the same plane or in parallel planes.

As a third optimised manufacturing possibility, it is proposed that each of said first and second spaces is defined by tubes arranged in at least a first and a second series located in the same plane or in distinct parallel planes, the first series forming said at least a first space and the second series forming said at least a second space.

As a fourth optimised manufacturing possibility, it is proposed that at least one of said first and second spaces is defined between a first plate and a second plate parallel to each other and joined together, and that the other of said first and second spaces is defined by a series of tubes arranged in the same plane or in parallel planes.

These solutions have various interests depending on the production method (extrusion/moulding/stamping, etc.), the material, the ease of adapting the solution to the shape chosen, the conformation of the desired paths for the flows, etc.

On this last point, it is noted that in the said first and second spaces, both parallel and crossed circulations can be defined for the said first and second flows (F1/F2).

Cross-circulations could be optimal if the flows are liquid to liquid and vaporisable in case of overheating of a cell.

The vaporisable flow will a priori be the one furthest away from the adjacent cell considered, because it is an overheating of a cell (which can be thermally managed by the other flow, during its nominal operating state) which can induce the vaporisation of the vaporisable stream.

Another battery thermal management assembly, comprising the above assembly, is also covered by the invention.

In this thermal management assembly, it is proposed to include:
several said cells or groups of said cells, and
a housing containing all of said cells, the housing peripherally comprising several sides and one or more of said walls per side, the housing surrounding on several sides:
the said cells considered all together, or
the groups of cells considered all together.

With the solution of the invention, it will be possible to obtain optimised thermal exchange:
that the walls enclosing said (first and second) spaces have thin peripheral edges which extend individually:
   either between two successive corners of the housing which limit its sides,
   or between two connectors by which two said walls would be assembled,
that the walls which enclose said spaces each extend in a plane perpendicular to said thin edge and along which the wall has a delimited surface (S), along said thin edge:
   either between two successive corners of the housing,
   or between two connectors, and
that said spaces in the walls of the housing occupy most of the surfaces (S) of these walls.

In another aspect, the invention relates to a vehicle comprising an assembly as aforesaid, with all or parts of its features, and in particular possibly a vehicle that can be driven:
comprising at least one such assembly, with several said cells connected with an electric motor, and
in at least one said wall which will extend facing a said side of at least one said cell, said at least first and second spaces will then contain, as said first flow and second flow, and this at the same or at different moments of operation of the cells, respectively a first flow of fluid (F2), present (dynamically, therefore) to circulate in a nominal operating state of the cells, and a second vaporisable flow (F1), originating from the same flow of fluid or from a different flow of fluid and adapted to be vaporised in the said second space, in the event of overheating of at least one said cell which is then no longer operating in a nominal manner.

In this vehicle it will even be possible that, since the cells have the nominal state in a first temperature range below a temperature threshold at which they overheat or deteriorate, said second flow of fluid (F1) which is contained in the second space of at least one said wall disposed adjacent to at least one overheating cell is actually present in this second space:
either in the nominal state of the cells and during overheating or deterioration,
or only during overheating or deterioration.

Whatever the choice, the point to note is that:
that the said second flow of fluid (F1) contained in the second space(s) can intervene preferentially as a flow of fluid adapted to present a vapour phase when at least one adjacent cell overheats and brings it to its vaporisation or boiling temperature,
and that the said first flow of fluid (F2) contained in the first space(s) can intervene preferentially as a flow of fluid adapted to maintain as far as possible the adjacent cell(s) in their nominal state of operation, without overheating.

In connection with the said second flow of fluid (F1), it is therefore in particular possible that it is a flow of fluid capable, at ambient pressure, of changing phase.

In the vehicle, it will then also be possible to ensure:
that said second flow of fluid (F1) is present in the second space, in the overheated state of at least one said cell with which it is in thermal exchange, so that at a temperature threshold of said at least one cell said second flow of fluid (F1) reaches its vaporization temperature, and—that the second space or spaces are open, to allow evacuation of said vaporized second flow of fluid (F1), out of said wall, to the external atmosphere.

The external atmosphere is that of the external environment surrounding the vehicle, and therefore the said assembly. The atmosphere and the external environment are therefore at ambient pressure (atmospheric pressure).

In connection now with said first flow of fluid (F2), and to ensure a dynamic, circulating presence thereof in the first space or spaces, it can be ensured that it communicates, in the wall containing it, with a flow inlet and outlet, and that
the vehicle further comprises a recycling circuit for recycling the said fluid from the outlet to the inlet and on which are disposed a means of forced circulation of the fluid and an exchanger for an exchange of heat between the first flow of fluid and another flow of fluid, one of which will then be connected to a pump or to a fan, thus ensuring a forced circulation of the first flow, in the wall.

A crack point could be the central zone of the housing, as the cells could be less easy to manage thermally.

Consequently, the following is proposed:
that the cells being distributed in the housing into several groups of cells, at least one of said walls extends between two groups of cells, such as an internal partition of the housing, and
that at least one of said (at least one) first and second spaces of said internal partition communicates with said respective spaces of other said walls of the housing, so that at least one of said first flow of fluid (F2) and second flow of fluid (F1) circulates, at a given time, from one space to another space of a said other wall.

This circulation will promote efficient heat transfer.

Further features can be provided in connection with the invention, and in particular, that, the cells thus having a nominal state in a first temperature range below a temperature threshold at which they overheat or deteriorate, the vehicle comprises:
a circuit for supplying and discharging a flow of fluid (F2) from at least some of said first spaces of the walls of the housing, and
a control unit which will then control the supply of said first flow of fluid (F2) at the inlet and/or the discharge of this flow at the outlet, so that said first flow circulates in said first spaces, while the cells are operating in the nominal state.

The invention also concerns a method of thermal management of at least one cell of an electric battery by means of at least one wall adapted to be in heat exchange with said cell, said wall enclosing at least one space in which at least one flow of fluid (F1, F2) adapted to be in heat exchange with at least one cell can be present, for its thermal management, this method being characterised in that said at least one space comprises at least one first space and at least one second space arranged parallel to each other:
at least while the said cell is operating nominally, a first flow of fluid (F2) is caused to circulate in the said first space, and,
at least in a situation of overheating of the said cell, which is then no longer operating nominally, a second vaporisable flow (F1), originating from the same flow of fluid or from a different flow of fluid and then contained in the said second space, is caused to vaporise out of the said second space, by heat transfer from the cell to the said wall.

It is recommended that:
that the first flow of fluid (F2) is caused to flow into said first space closer to said cell than is the second space containing the second vaporisable flow (F1).

Thus, the thermal exchange with the cell will be optimized for nominal operation and/or;
that the second vaporisable flow (F1) is present in the second space only in the situation of overheating of said cell, when it no longer operates in a nominal manner.

In the first case, the thermal exchange with the cell will be optimised for nominal operation. In the second case, the second vaporisable flow (F1) will be kept in reserve, at optimum temperature.

### BRIEF DESCRIPTION OF THE FIGURES

FIG. 1 shows a vehicle, such as a car, provided with a housing according to the invention;

FIG. 2 shows an example of an electric battery cell housing according to the invention;

FIG. 3 shows a wall (hereinafter sometimes referred to as the first wall or second wall, such as 11-11b1 or 11-11b2) of the housing;

FIG. 4 is an exploded view to show how a functionalised wall can be made in accordance with the invention, as marked 11 or 11-11c below; different pull-outs detail enlarged areas;

FIG. 5 shows an assembly according to the invention for an electric battery thermal management, the assembly comprising at least a first and a second wall (in the example two pairs) joined by a connecting block.

FIG. 6 represents the housing of [FIG. 2], three pull-outs A,B,C detail possible enlarged areas;

FIG. 7 represents a wall of the housing (called the first wall) and a connecting block (marked 31) to be engaged with each other;

FIG. 8 shows an exploded view of an example of a housing according to the invention, with cells and with an assembly skeleton (59);

FIG. 9 shows an assembled state of the view in [FIG. 8], without cells and in perspective from the top;

FIG. 10 shows an assembled state of the view in [FIG. 8], without cells and in perspective from the top;

FIG. 11 shows the assembled state of the view in [FIG. 9], with cells and additional elements to be placed on top and underneath for their thermal and/or mechanical protection,

FIG. 12 represents, in relation to [FIG. 2], a part of the circulation path of the flow of fluid referred to as F2, in case of recycling, with associated means that can be provided, in an example,

FIG. 13 shows the housing and its electrical cells of [FIG. 2], without recirculation of the flow of fluid F2, but with two wall details, in pull-out, and

FIG. 14 shows, in more detail than [FIG. 13], a corner zone of the thermal management side enclosure which can surround the housing, and in which a flow of fluid F3 can flow, in one example,

FIG. 15 shows an alternative design of the cells, i.e. the housing of the invention;

FIG. 16 represents another alternative embodiment of the cells, with a housing in accordance with the invention which can be as in [FIG. 1] to [FIG. 8];

FIG. 17 shows yet another alternative embodiment of the cells, with a section along line XVII-XVII of [FIG. 16] and a housing in accordance with the invention which can also be like that of [FIG. 1] to [FIG. 8],

FIG. 18 shows an alternative circulation of flows F1 and F2, with a 90° tilt of the double wall compared to the position in [FIG. 3],

FIG. 19 shows a housing in accordance with the invention, with hollow walls as in FIG. 4, assembled, with the F1 flow of fluids circulating “in parallel” shown, in some places (not to overload the figure); and

FIG. 20 shows the same housing as FIG. 19; the flows F1 of fluid (still crossed at 90° with respect to the flow F2) are shown, in some places,

FIG. 21 shows a housing according to the invention, tilted at 90° to any of the previous cases, with the cells still upright,

FIG. 22 shows the solution of FIG. 22 with a partial exploded view at the location of one of the hollow walls and two connectors that border it coplanarly,

FIG. 23 shows an alternative solution where one of the double plates of the solution in FIG. 4 is replaced by a series of tubes occupying almost the same major surface as in the case in FIG. 4; and

Another alternative solution is shown in [FIG. 24], where the two groups of three plates of the solution in FIG. 4 are each replaced by a double series of tubes, each occupying almost the same major surface as in the case of FIG. 4,

FIG. 25 is an alternative design and relative positioning between cells and a wall 11,

FIG. 26 is a local exploded view of FIG. 25,

FIG. 27 is an alternative design and relative positioning between cells and a wall 11,

FIG. 28 is a local exploded view of FIG. 27,

FIG. 29 is an alternative design and relative positioning between cells and a wall 11,

FIG. 30 is a local exploded view of FIG. 29,

FIG. 31 is an alternative design and relative positioning between cells and a wall 11,

FIG. 32 is a local exploded view of FIG. 31,

FIG. 33 is an alternative design and relative positioning between cells and a wall 11,

FIG. 34 shows, for better visibility, the layer of tubes offset from the cells.

### DETAILED DESCRIPTION OF THE INVENTION

In connection with the mentioned figures, the following refers to non-limiting examples.

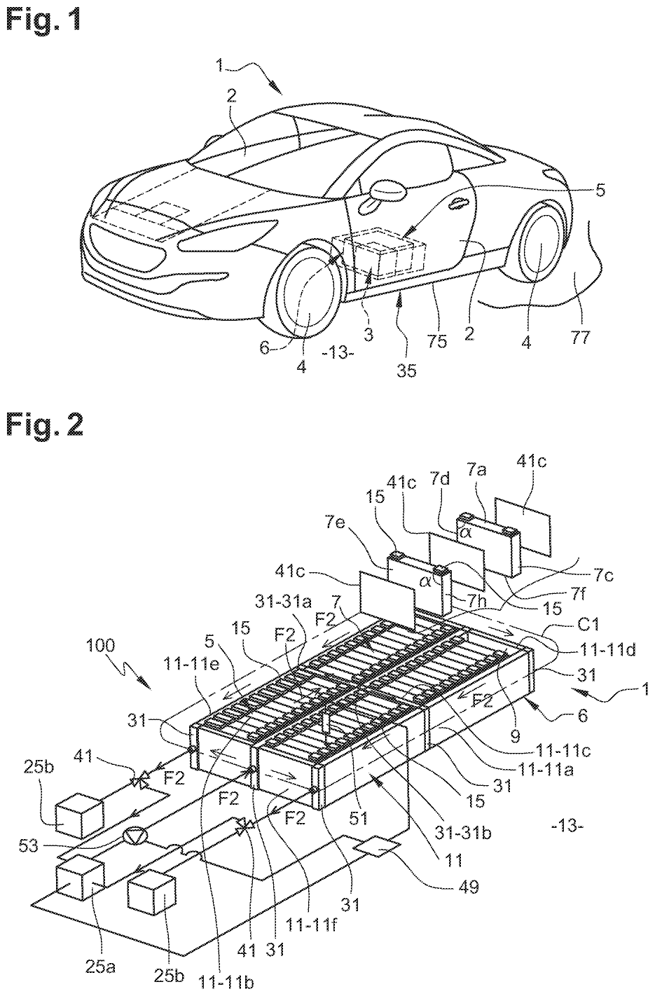

FIG. 1 shows a vehicle 1, a car in this example, which comprises for its movement (and thus for driving on the ground 77, via the wheels 4) at least one electric motor 3 powered by an electric battery 5 with which the motor 3 is thus electrically connected.

The vehicle 1 can thus be electric or hybrid.

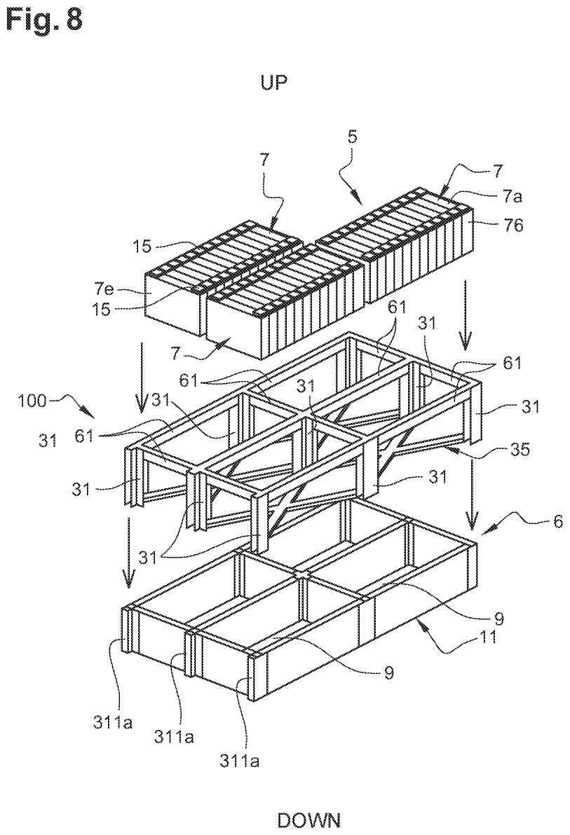

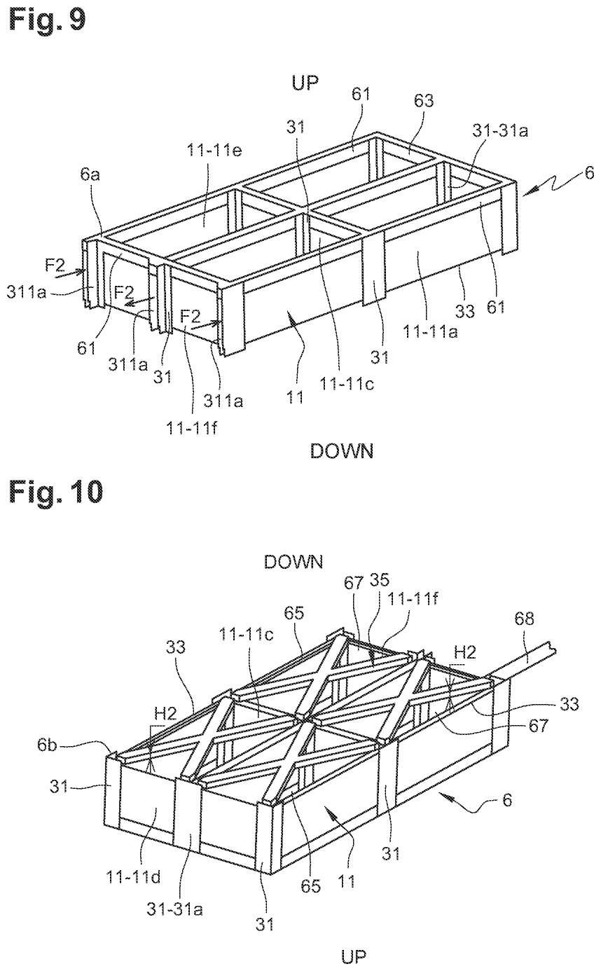

In FIG. 2, in the vehicle 1, the cells 7 (see also FIG. 8) of the battery 5 adapted to have electrochemical activity are contained in at least one inner space 9 bounded peripherally by walls (or faces) 11 of the housing 6.

The housing 6 is arranged in the surrounding external environment 13, which is also that of the vehicle 1.

The housing 6 is polygonal. Each of its sides extends parallel to a face of a cell or series of cells that are parallel to each other.

The battery 5, and thus its cells 7, is placed on the vehicle chassis or floor 75, which is assumed to be horizontal and which can include the (horizontal) bottom plate 35 mentioned below.

The battery 5 and the housing 6 that contains and surrounds it on several sides could also be placed on a vehicle, such as a ship, where a battery connected to an engine would need to be protected.

Each cell 7 has:
a connection face, or side, 7a where electrical connection terminals 15 for electrical exchanges are located,
lateral faces, or sides, 7b-7e which form an angle with the connection face and are adjacent to it, and
a face or side 7f opposite the face 7a and can be the bottom face.

In some figures, INF and SUP indicate what is in the lower or upper part, zone or face respectively.

The angle (FIG. 2) can be a right angle α: a frequent case of parallelepiped cells.

A priori, the connecting faces 7a of all cells will be identically oriented in the interior space 9. Of the lateral faces, each cell 7 has at least two opposing side faces 7b,7e which define the largest surfaces of each cell.

The walls of the cells 7 are therefore, in the example chosen, rectangular parallelepipeds.

At least some of the walls 11 are functionalised, as already explained and as further detailed below.

In this respect, at least one of these walls 11 is functionalised:
extends between groups of cells, or between cells, thus forming at least one partition, such as 11-11b or 11-11c FIG. 2, which compartmentalises the interior space 9 of the housing, or
extends around the periphery of the groups of cells, or of all the cells, such as the walls 11-11a or 11-11d FIG. 2.

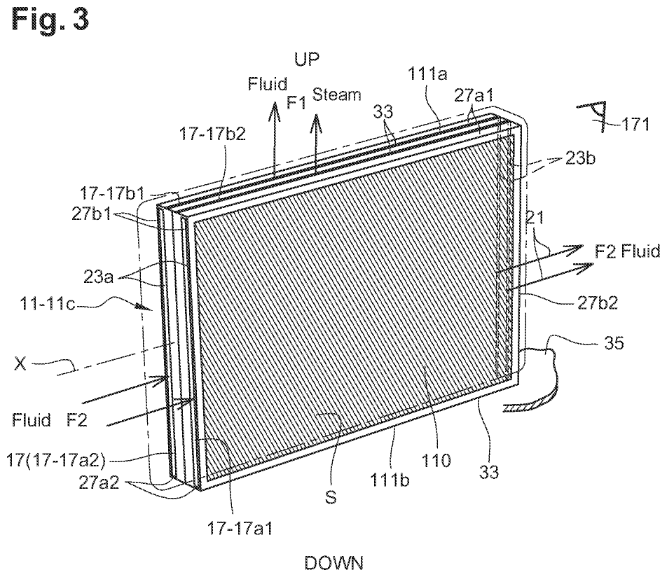

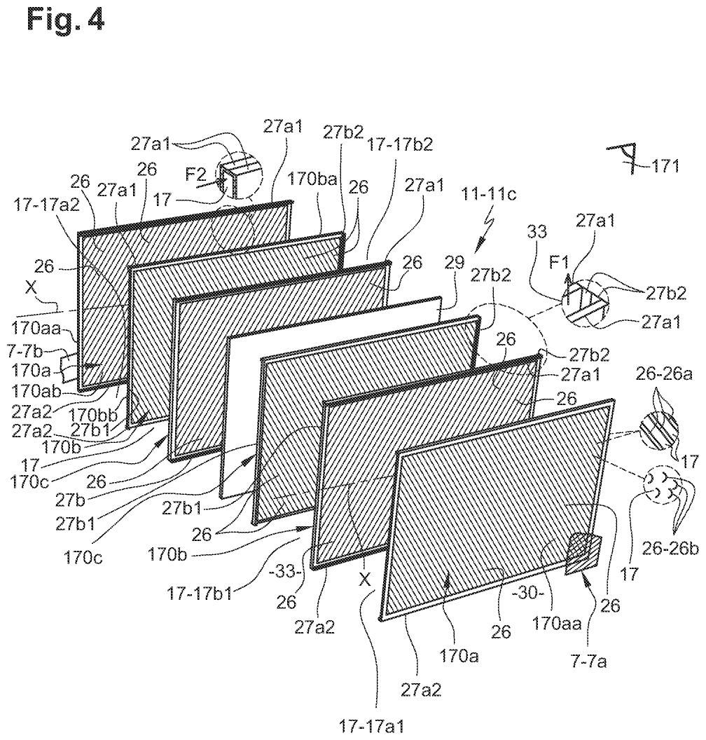

Functionalised, each of these walls, as for example wall 11-11c, FIGS. 3-4 (it could also have been referred to as 11-11a or other):
is in thermal exchange with some of the cells 7 and/or with the external environment 13, and
encloses at least one space 17 in which, at a given time, a flow of fluid (F1 or F2, FIG. 3) can be present, in heat exchange with some of the cells 7.

The phrase “at a given time” indicates that the above-mentioned flow of fluid is present in space 17:
in the nominal state of the cells (while they are generating electrochemical activity or electric discharge), thus following their so-called first temperature range below the overheating threshold,
and/or in an abnormal state of at least one cell with which the flow of fluid is in thermal exchange, adjacently, the temperature of this cell being then beyond said threshold: it overheats.

Functionalised in accordance with the invention, each said wall is further such that:
that said at least one space 17, and thus the corresponding wall (such as thus 11-11c), has a flow of fluid inlet 23a and outlet 23b,
that, in a flow of fluid-tight manner (via seals if necessary), the flow of fluid inlet 23a and outlet 23b communicate with, respectively, a supply 25a of thermal flow of fluid and a discharge 25b of said flow of fluid, so that the flow of fluid can circulate in said at least one space 17.

In addition:
by the surrounding wall (the structural material 110 of this wall 11-11c, in the example; FIG. 3) and by the said sealed communications, the space under consideration is physically isolated from the cells 7, so that the flow of fluid present therein (flow of fluid F2 in the example of FIG. 3) and the interior space 9 of the housing do not communicate, and
this same wall extends laterally, parallel to at least one of the lateral faces 7b-7e of at least one said cell 7.

In particular, the flow F2 can advantageously be a liquid flow, which is more thermally efficient than a gas flow, such as a glycol water flow.

Since the risk of leakage is prevented and enlarged thermal exchange surfaces are available, it will be possible to provide that the supply 25a of the thermal flow of fluid is a liquid supply, so that this liquid F2 reaches, via the inlet 23a, the said at least one space 17, and then passes from wall 11 to wall 11 (in the successive spaces 17).

The exploded view of FIG. 4 shows how a said functionalised wall can be made according to the invention, such as 11-11c.

Each such wall can thus comprise at least one plate 170a having first and second opposite faces 170aa, 170ab at least one of which has flanges 27a1, 27a2 and/or, 27b1, 27b2, and possibly also protrusions 26 defining, respectively between the said flanges (27a1, 27a2 or 27b1, 27b2) and possibly between the protrusions, the said at least one space 17.

Each plate 170a is generally flat, and rectangular in the example.

In the example, the protrusions 26 are formed by straight ribs or corrugations 26-26a parallel to each other (see local enlargement FIG. 4) which extend at an angle. Alternatively, on the relevant face, the protrusions 26 could be formed by granulation or local (occasional) embossments 26-26b (see further local enlargement FIG. 4).

In each case, the tops of the protrusions 26 are applied against each other, abutting from one plate to the other, and the gap 17 is defined by the spaces between the respective straight ribs or embossments of the two plates, outside their crossing or abutting areas. Two identical plates, such as 170a, 170b, one rotated with respect to the other by 180° about a median horizontal axis X contained in the plane 171 of these plates, and therefore of the wall 11 (11-11c FIGS. 3, 4) concerned, applied against each other will define between them a so-called space 17 (marked 17-17a1 or 17-17a2, FIG. 4). Thus arranged, these two plates 170a, 170b are such that their respective flanges 27a1, 27a2, located at the upper and lower horizontal edges respectively, are horizontal (parallel to the X axis), face each other and abut each other in pairs (see enlargement at the top of FIG. 4).

In this way, the flow of fluid concerned (F2 in the example; but it could be the flow F1, see FIGS. 18 and 20) will be channelled horizontally and will be able to flow from the said space 17-17a1 or 17-17a2 (known as the first space) of a wall to the same space of the wall which is adjacent to the previous one, along the X axis.

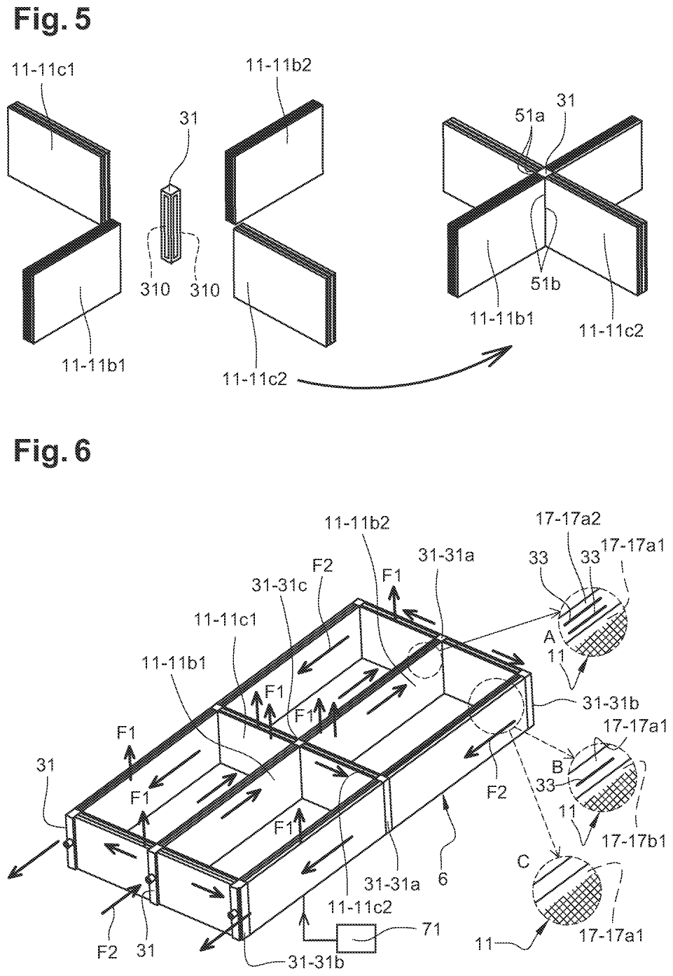

Between two such first and second successive walls, such as 11-11b1, 11-11b2 or 11-11c1, 11-11c2 FIG. 5 or 6, a hollow connecting block 31 (also called a connector) enclosing at least one space 310 communicating with the aforementioned spaces of these respective walls (such as 11-11c or 11-11a), (such as 11-11c or 11-11a), respectively, will allow the flow of fluid F2 to circulate laterally, horizontally, in the inner space 9 or at the periphery of the housing, successively from wall 11 to wall 11, as illustrated by the arrows F2 in FIG. 6 (where the arrowed circulation is, however, only an example).

In pull-outs FIG. 6, two different zones have been enlarged
in the first zone surrounded by dotted lines and corresponding to enlargement A, an intermediate wall 11 in the heart of the housing 6 is detailed; Since it is located between two (groups of) cells 7, the wall has (preferably), internally, the two spaces 17-17a1 and 17-17a2 (for the circulation of the flow of fluid F2), and, preferably, the other two safety spaces, with the openings 33 (through which the flow of meltable fluid F1 can escape), and
in the second zone surrounded by dotted lines and corresponding to enlargement B, another wall 11 is detailed, this time peripheral to the housing 6; Since it is located around the (groups of) cells 7, the wall has, internally, a space 17-17a1 (for the circulation of the flow of fluid concerned) and an opening 33 (through which the other flow of fluid F1 or F2 can escape, depending on whether we are in the case of FIG. 3 or FIG. 18); solution B FIG. 6 as an example.

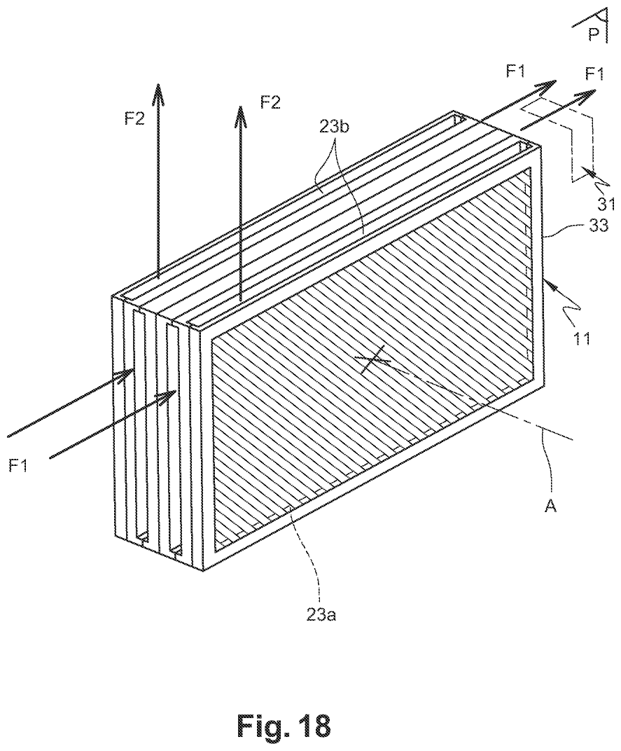

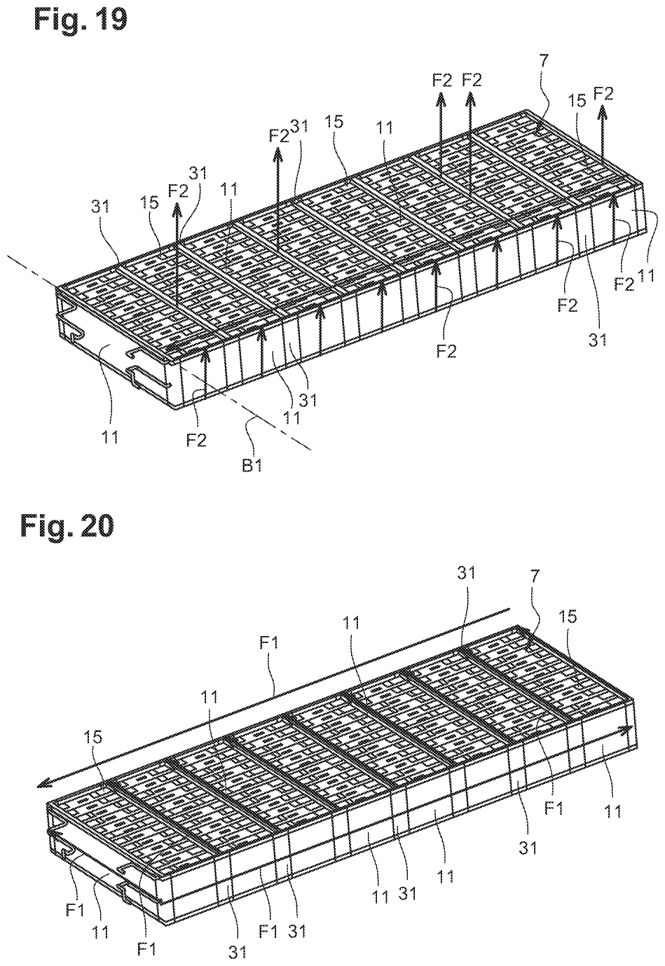

It should be noted that solution B could also be provided, as a degraded solution, in the intermediate walls at the heart of the housing 6, between two groups of cells, instead of solution A. It should also be noted in FIG. 6 that the arrows (in thick bold) for the circulation of the flow of fluid (F2 in the example) are therefore only a non-limiting example. Other routes from wall 11 to wall 11 are possible; see FIGS. 19-20.

The internal circulation space(s) 310 in the connecting blocks 31 can be different from that in FIG. 6, depending on the location of the connecting block and the number of spaces in the successive walls 11 to be connected in pairs.

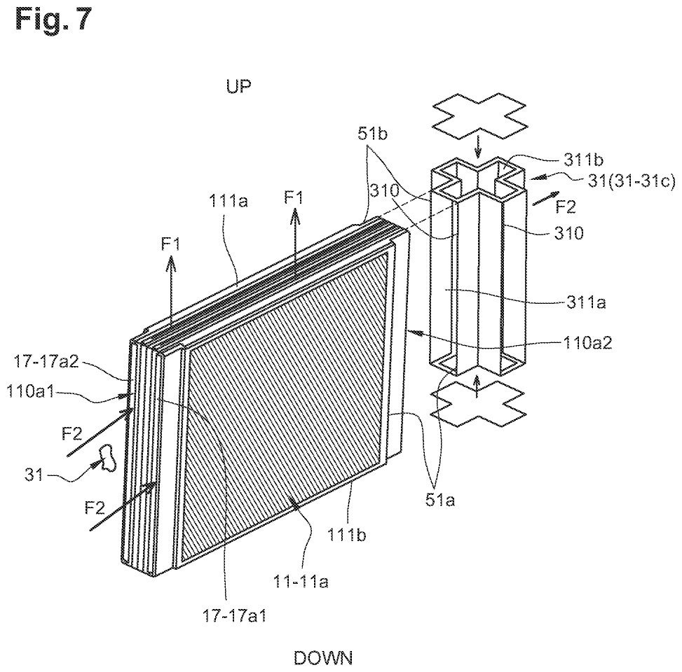

Thus, it is possible to have aligned spaces 310 (where, for example, only the walls 11-11b1, 11-11b2, FIG. 5, need to communicate), in a T-shape (block 31-31a, FIG. 6), in an L-shape (block 31-31b), in an X-shape (block 31-31c; see FIG. 7), in particular.

To also combine modularity, compactness and flow of fluid distribution in the housing 6, it is also proposed that the (each) connecting block 31 has at least two mouths, as 311a, 311b FIG. 7:
to which the first or second open lateral side 110a1, 110a2 of said first and second walls open, respectively, and
each communicating with said at least one space 310 of the connecting block, for an inlet or outlet of said at least one thermal flow of fluid, such as F2.

In order to ensure a sealed communication preventing the flow (in particular F2) of fluid from reaching the internal space 9 of the housing, one (each) wall 11 and one (each) connecting block 31 can be placed in end-to-end contact (see wall in FIG. 3) or engaged one in the other, two by two (see FIG. 7), and for example welded together, thus ensuring a tight mechanical connection (see references 51a, 51b FIG. 5.7).

As already mentioned, another space (called “second space”) for thermal management (marked 17-17b1 or 17-17b2, FIG. 4), with a flow of fluid F1 present therein at least in an abnormal situation of overheating of at least one of the cells 7, can therefore be provided in each wall 11.

For this purpose:
on the back of the plate 170b (face 170ba FIG. 4), in addition to the possible protrusions 26, two flanges 27b1, 27b2 extend along the vertical edges of the plate,
and a third plate 170c (FIG. 4) is provided, identical to the plate 170b, but rotated one by one through 180° about said median horizontal axis X contained in the plane 171 of these plates, and therefore of the wall 11 (11-11c FIG. 4) concerned.

Thus arranged, these two plates 170b, 170c are such that their respective lateral flanges 27b1, 27b2, located at the vertical left and vertical right edges respectively, on either side of the protrusions 26, are vertical (perpendicular to the axis X), face each other and abut each other in pairs (see enlargement on the right of FIG. 4).

In this way, the flow of fluid F1 will be channelled vertically and will be able to escape through the opening (the slit) 33 in the upper horizontal part of the space concerned, such as that 17-17b1 FIG. 4; see also FIG. 3.

In the lower horizontal part of the same space 17, the same opening (or slit) 33 can exist. Thus, it will be possible to supply internally, with a flow of meltable fluid F1 and when the time comes, the (each) space concerned with one or more walls 11, from a source 71; see FIG. 6. Seals can be placed there to seal the flow of fluid, if necessary.

At least in the aforementioned second space (17-17b1 and/or 17-17b2 FIG. 4), and for dynamic presence via source 71, the inlet or outlet of this second space will be connected to a pump or fan (73; FIG. 6), providing a forced supply of flow of fluid F1 to the inlet.

At least one fan or at least one pump 53. 43 will do the same thing for the flow of fluid F2 (see below). And the same for a flow of fluid F3, if any: see below and supply 79 of flow of fluid F3 connected to inlets 322 in wall(s) 37 (respective spaces 17-17c), via a pump or fan (mark 81 FIG. 13). Outlets 323 allow the flow of fluid F3 to exit the wall(s) 37, thus the respective spaces 17-17c, after having circulated there.

Seals can be placed at the inlet and/or outlet of the housing to seal the flow of fluid F3, if required.

Through channels (not shown) open in at least one bottom plate 35 (see FIG. 3) extending under the wafers of the walls 11 (but preferably also under the entire bottom of the housing 6 and under the cells 7), the flow of fluid F1 could furthermore circulate between the (second) space 17-17b1 and/or 17-17b2 of one wall and the same (second) space of the wall which is adjacent to the previous one, so as to create a situation of communicating vessels, making it possible to balance the levels in the spaces, in particular if the flow of fluid F1 is a liquid (or has at least one liquid phase in the nominal state of the cells).

The flow of fluid F1 will be a vaporisable fluid, such as water (brine or not).

To optimise the safety/thermal management trade-off, this flow of fluid F1 will thus be usefully adapted to change phase, at ambient temperature and pressure (20° C.; atmospheric pressure).

In FIG. 4, the wall 11-11c is formed by a pair of double spaces, 17-17a1, 17-17b1 and 17-17a2, 17-17b2 respectively, these two double spaces being separated by an intermediate thermal insulation plate 29.

Indeed, the wall 11-11c, like the wall 11-11b, is one of those that extends between two cells 7, thus in the interior part of the housing, in the space 9 that these walls compartmentalise. Crosswise, such compartmentalisation further increases the mechanical strength of the housing 6 and the thermal management of the cells.

On either side of the thermal insulation plate 29, each space 17 (e.g. 17-17a1 or 17-17b1) is in thermal exchange with at least the cell 7 adjacent to it.

Thus, the plate 170a (its external face 170aa) stands against one of these cells. If an air film 30 exists between them, especially due to the protrusions 26, no flow of fluid is there.

The thermal insulation plate 29 acts as a shield, so that overheating in one cell 7 does not spread to another. The above-mentioned double-space pair acts on both sides.

On the external periphery of the housing 6, however, a single wall (such as 11-11a, 11-11d) (a series of such successive walls), with or without a thermal insulation plate 29 at its own external periphery, can be sufficient.

Thus, with, for each functionalised wall 11, a first and a second space (17-17a1 and 17-17a2 or 17-17b1 and 17-17b2), or even a pair of such first and second spaces (as shown in FIG. 3), there will be first and second spaces:
which will not communicate with each other,
which will be adapted so that the said at least one thermal flow of fluid (such as F2) and another flow of fluid (such as F1) are present therein, at the same time or at different times, respectively, the first flow of fluid being present dynamically, the other flow of fluid being able to be present statically or dynamically: Without an opening 33 in the bottom of the wall, in the said second space 17-17b1, or 17-17b1 and 17-17b2, the flow of fluid F1 will be present statically, otherwise it will be present dynamically, as it is in circulation (the communicating vessel implying a circulation).

With the static or dynamic presence of such flows of fluids F1 and/or F2 on the lateral faces of the housing (thus, in the examples up to FIG. 20, neither on the top face, nor on the face where the terminals 15 are, nor on the bottom face, where the bottom plate 35 will be found), the housing 6 will in any case comprise several said functionalised walls 11 each having said at least one space 17 standing around the cells 7, or groups of cells, to define at least a part of the housing 6, which will completely surround the cells (arranged with their terminals 7 on the upper or lower horizontal face), or groups of such cells, on several adjacent sides of the housing.

More specifically, it is intended that these functionalised walls 11 define a closed outer contour (or perimeter) C1 of the housing, extending around the cells 7, considered all together (as in FIG. 13), or around the groups of cells considered all together (as in FIG. 2).

It is also possible, to further improve control and thermal safety, that the functionalised walls 11 extend between two or more groups of cells, to partition the housing 6, as shown in FIG. 2 (see for example walls 11-11c1 and 11-11c2 in FIG. 6).

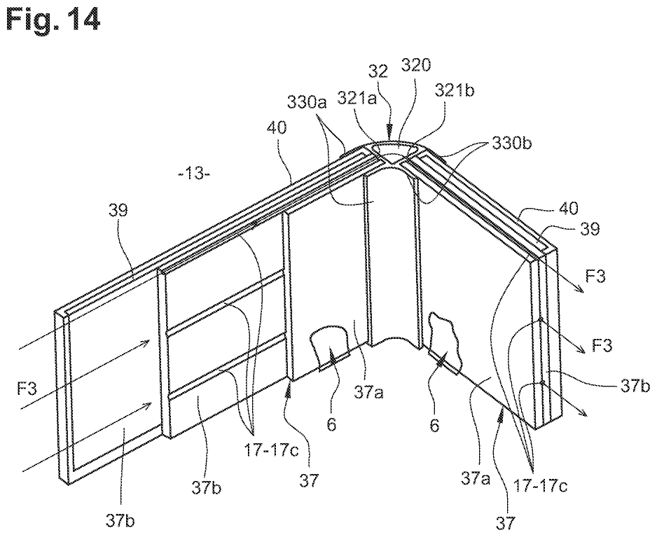

If we return to the situation at the external periphery of the housing 6, it will be possible to provide a complementary circulation of another flow of fluid, F3 (see FIGS. 13, 14), intended a priori to recharge the PCM, at the external periphery of the housing (see below).

The following in connection with the flow of fluid F3 is independent of the above description in connection with the figures. The flow of fluid F3 will a priori be different from the flow(s) of fluid F1 and/or F2. The flow of fluid F3 can be gaseous, such as air, which can be ventilated and therefore under pressure.

Thus, whatever the way of realising said functionalised walls 11 and their internal spaces 17, it can be useful (always in terms of thermal management of the cells) that at least one layer or plate of thermal insulation 39 (which can be a Vacuum Insulation Panel, VIP) can be interposed (standing vertically on the lateral face of the housing) between the wall 37 containing the third space 17-17c and an external mechanically protective wall 40 adjacent thereto; see FIGS. 13, 14.

At least one further layer or plate of phase change material (PCM) 41a, 41b can even be interposed (standing vertically on the lateral face of the housing) between the thermal insulation 39 and the wall 37 containing the third space 17-17c.

One or two layers or plates of PCMs 41a and 41b containing PCMs of different phase change temperatures can be able to cope with external environmental temperatures 13 that can be very cold at one given time and very hot at another given time.

The (each) wall 37 can comprise two plates 37a, 37b (FIG. 14) with channels running through them (in the example horizontally) along the walls 11 of the housing parallel to it, forming said third space 17-17c; see FIGS. 13, 14.

The material of the plates 37a, 37b contains PCM in a rigid structural matrix. This will preferably be PCM (phase change material) in a polymer matrix.

In particular, the flow of fluid F3 through the channels will allow the regeneration of the PCM when required.

In this way, a self-supporting composite body will be available regardless of the phase of the PCM (solid or liquid in particular). The channels, tubes or conduits of the peripheral passage of the flow of fluid F3 can be integrated or added (tubes or conduits) to the wall 37.

With such a combination of PCM, the circulating flow of fluid F3 and a thermal insulator around it, it will be possible to create an efficient dynamic thermal barrier.

Between two adjacent walls 37, consecutive along the circulation path of the flow of fluid F3 along the walls 11 of the housing 6, parallel to the circulation path of the flow of fluid F2, if there is one, will be interposed a complementary connecting block 32 which can be functionally identical to the connecting block 31.

Thus, each complementary connecting block 32 comprises an inner space 320, and at least two mouths (depending on the shape in I, X, L as in FIG. 14, T . . . ) such as 321a, 321b FIG. 14:
on which said third spaces 17-17c of the walls 37 open laterally, and
each communicating with the interior space 320, for an entry or exit of the thermal flow of fluid F3, and thus for its lateral circulation around the housing 6, along the walls 11 and the blocks 31.

In order to ensure a tight connection to prevent the flow of fluid (here F3) from entering the inner space 9 of the housing, the (each) wall 37 and the (each) complementary connecting block 32 can be fitted together in pairs (see FIG. 14) in a tight manner, thus ensuring a tight mechanical connection (see marks 330a, 330b FIG. 14).

Thus, it will be understood that on the external periphery of the housing 6, at least on the aforementioned contour C1, or on this contour C1 and between two groups of cells 7 (as an intermediate partition as aforementioned), one can thus find:
either the two flows of fluid F1, F2, thus with side walls (such as 11-11a, 11-11d) each simple (with two adjacent parallel side spaces, such as 17-17a2 and 17-17b2),
or the three flows of fluid F1, F2, F3, thus with walls each laterally erect, with three adjacent side spaces, such as 17-17a2, 17-17b2 and 17-17c, as shown in FIG. 13.

In each case, all the spaces where the flows of fluids (respectively F1, F2, F3 or F1, F2) are parallel to each other and adjacent (thus present on the same face of the housing) can be integrated into the same so-called functionalised wall.

Note also that wherever the flow of fluid F1 is coupled with the flow of fluid F2, the space (17-17b1 or 17-17b2) of the flow of fluid F1 will be arranged laterally adjacent to, but outside, the space of the flow of fluid F2. Thus, there will be:
a cell 7, then
the (so-called first) space (17-17a1 or 17-17a2) of the flow of fluid F2, then
the (so-called second) space (17-17b1 or 17-17b2) of the flow of fluid F1.

Further away from the cell, there could be either an insulator 29 or the space 17-17c of the third flow of fluid F3.

Thus, if (at least) one electrical cell, such as 7-7a FIG. 4, adjacent to a “functionalised” wall, such as 11-11a, generates electrochemical activity:
it will naturally heat up in its so-called nominal state, within a first temperature range (e.g. between 20 and 35° C. for Li-ion cells) below a threshold, e.g. 35° C. in the above case,
but it can, at a given time, reach an abnormal state, overheating beyond said threshold or deteriorating.

The same applies to cell 7-7b adjacent to space 17-17a2 located opposite this wall 11-11c, which in the example is therefore a partition between two groups of cells 7.

At least when this abnormal state is reached, and preferably already in the nominal state, a flow of fluid F1 will be present in said second spaces (17-17b1; 17-17b2).

Furthermore, preferably during this nominal state, the temperature of these cells such as 7-7a 7-7b will be able to be thermally managed by heat exchange between them and the flow of fluid F2 circulating in the (so-called first) space (17-17a1 or 17-17a2) closest to the cell concerned.

If provided, the insulating layer 29 will act as a thermal shield between the two groups of cells to which the cells 7-7a and 7-7b respectively belong.

The thermal exchange between the flow of fluid F2 and the nearest cell will limit the risk of overheating, all the more so with a flow of liquid fluid and the fact that the cells are on their lateral faces (7b-7e), and therefore have the largest exchange surfaces.

If overheating still occurs, the heat from the cell will heat up the flow of fluid F1 present in the said second closest space (17-17b1 or 17-17b2).

This can lead to a phase change of this flow of fluid which, if it reaches its vaporisation temperature and thus vaporises (at ambient pressure), can then be evacuated in the gaseous phase through the opening 33 of the space concerned (arrows F1 FIG. 3 or 18). It should also be noted that, unlike the periphery of the housing 6 which is at the interface between the external environment 13 and the cells 7, the entire part of the interior space 9 of the housing which can extend between two groups of cells 7 will otherwise be favourably reserved exclusively for the thermal exchange between:
the (each) above-mentioned functionalised wall (such as walls 11-11b, 11-11c) forming at least one said partition, and
at least the cells 7 which are adjacent to it, so that no phase change material will then be disposed, either in these walls (see FIG. 4 where no PCM is provided) or between them and the adjacent cell 7 considered.

This will optimise the compromise between mechanical strength/size/weight/thermal management.

On the other hand, a layer or plate of PCM 41c can be placed between two successive (adjacent) cells 7 for the same purpose, as shown in FIG. 2. Each PCM 41c will smooth out the thermal jolts of the cells adjacent to it.

As for the fluid F3, the following in connection with the circulation of the flow of fluid F2 is independent of the above description in connection with the figures.

As already noted, the thermal flow of fluid F2 is dynamic. It will thus be possible to take advantage of the fact that it exits from the walls 11, and therefore (from the interior space 9) of the housing 6, via the outlets 23b, so that its discharge 25b communicates via a recycling circuit 39 which makes it possible to recycle at least part of the flow of thermal fluid to the supply 25a; see FIG. 2.

At least one three-way valve 41 with a variable flow rate can be used to recycle all or part of the flow of fluid F2 leaving the housing 6, including in the solution shown in FIGS. 18-19, in which a collection cover (not shown) can be placed over the open face of the housing from which the openings 23b emerge.

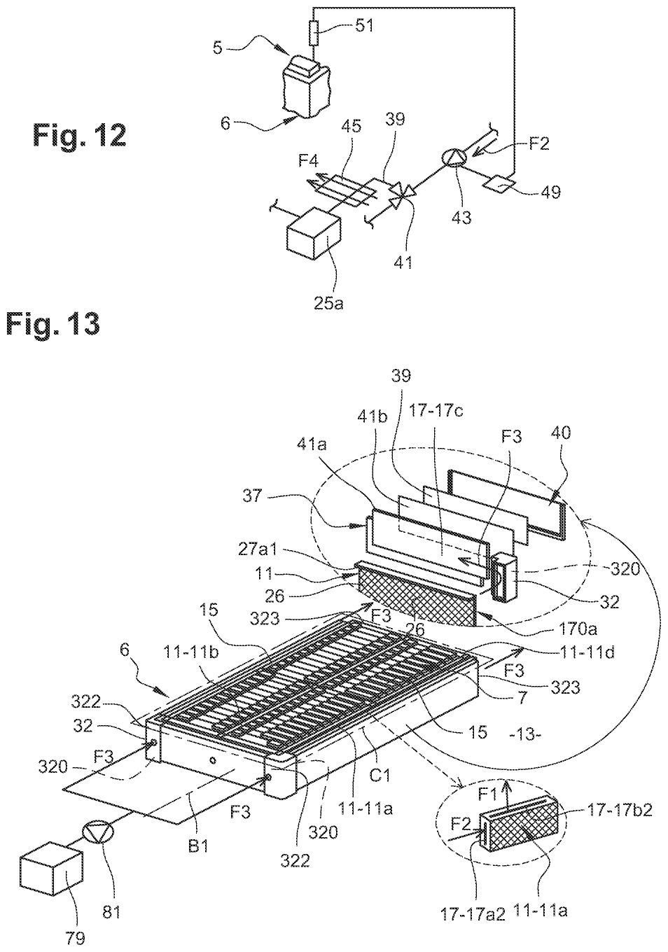

In order to promote energy efficiency, a forced circulation means 43 (pump if the flow of fluid F2 is a liquid, fan if it is a gas) and an exchanger 45 (between the flow of fluid F2 and another flow of fluid F4) will be found on the recycling circuit 39, in order to a priori cool the flow of fluid F2 and recycle it in 25a colder than it left the housing; see FIG. 12 where, as in FIG. 2, the circulation path of the flow of fluid F2 is provided only as a non-limiting example. With regard to this flow of fluid F2, it can be of interest that a control unit 49 (FIG. 12) controls the supply of this flow of thermal fluid at the inlet and/or the discharge of said flow of fluid at the outlet, so that the flow of fluid F2 thus circulates in said at least one space 17; 17-17a1, 17-17a2 while the cells 7 are in the nominal state.

A priori, it should also be of interest that this flow of fluid F2 also circulates in the said at least one space 17; 17-17a1, 17-17a2 while the cells 7 are in an abnormal state: below or above the minimum and maximum temperature thresholds for nominal operation of the cells, i.e.:
below 10° C. in minimum temperature threshold, and
above 35° C. in maximum temperature threshold.

Whether or not the flow of fluid F2 is recycled, a control unit 49 can be connected to at least one temperature sensor 51 sensing the temperature of the (at least one) cell(s) 7; FIG. 2.

The control unit 49 can be connected to at least one temperature sensor 51 sensing the temperature of the (at least one) cell(s); FIG. 2.

For a forced supply of flow of fluid F2 in the absence of recycling (or as a substitution of the means 43), a circulation means 53, connected with the control unit 49, will ensure the forced circulation of said flow of fluid, in the housing 6 (its walls 11).

The control unit 49 can also be connected to the three-way valve(s) 41 for control; FIG. 12. As with the fluid F3 and the circulation of the flow of fluid F2, the following in connection with the circulation of the flow(s) of fluid F1 and/or F2 and/or F3 in the housing 6 is independent of the above description in connection with the figures.

Thus, with regard to this circulation of flows of fluids F1 and/or F2 and/or F3, and whether there is one such flow (F1 or F2), two (F1 and F2) or three (F1, F2 and F3), the following should be noted:
in relation to the flow of fluid F1; this is therefore a fusible flow of fluid, the circulation of which is responsible, by boiling or vaporising the flow of fluid F1 in the corresponding space of the wall 11 in question, for ensuring the removal of heat during a thermal runaway of a cell and/or a group of cells, —in relation to the flow of fluid F2; this is therefore a flow of fluid, the circulation of which is responsible for ensuring the maintenance of the nominal state of the cells 7 during their operation (electrical production):
cooling if they are heating,
   heating if they are still cold, because if a cell has to operate at too low a temperature (for a Li-Ion cell, an operating temperature between +10° C. and +35° C. is ideal; in nominal terms, the allowed temperature range in charge can be considered to be between 0 to +45° C., and −20° C. to +60° C. in discharge).

For example, it can be advisable to heat the cells to encourage charging if the outside temperature is below 10° C., for example after parking in cold weather in winter.

However, for the sake of misleading language, this text generally refers to a “cooling circuit”, as cooling is likely to be more frequent than heating.

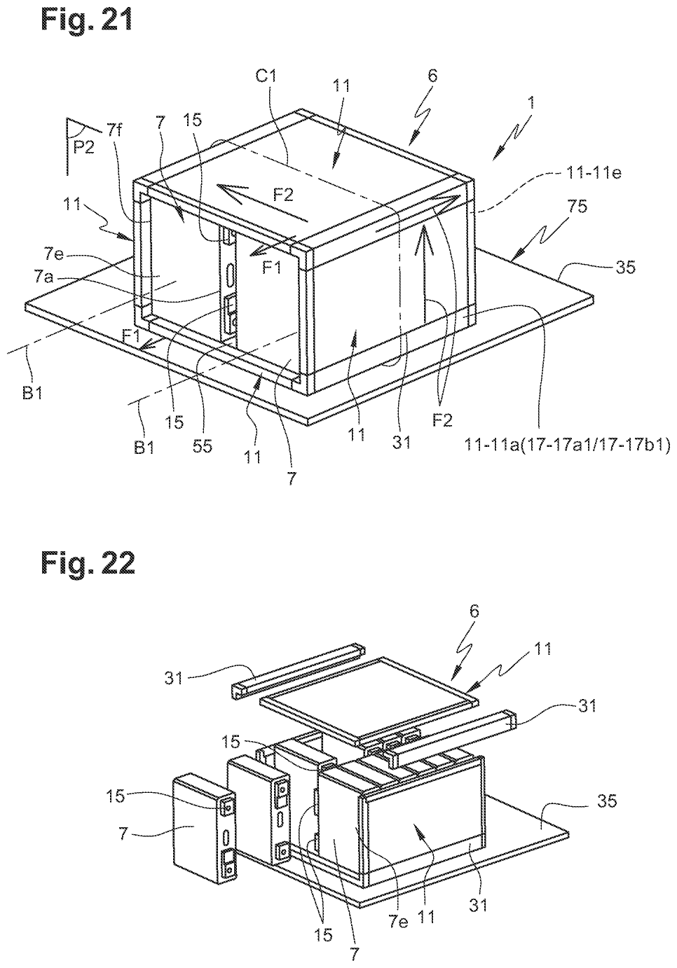

Providing for a flow of thermal fluid only underneath cell 7, as already proposed on certain vehicles, is however inappropriate (accessibility, efficiency, insufficient maintenance, etc.). The positioning (as in the invention) on several sides of the housing, and thus of the cells, and which can in particular be perimetric (over the entire closed contour C1 FIG. 2 or 21), of this cooling circuit, with walls 11 typically extending to the external periphery of the housing 6, should make it possible to remove the heat produced by the cells very efficiently. In particular, it should make it possible to deal with hot spots near connections 15.

If this peripheral positioning, on several sides, is present:
on (at least) the two opposite lateral faces of greater length of the cells, as in FIG. 2,
or in a plane P2 perpendicular to an axis B1, or to several axes B1 parallel to each other (as in FIG. 21) of alignment of the cells 7 by their greater faces 7b, 7e, it makes it possible to increase the exchange surface zone considerably compared with an exchange surface zone under the cells, and this without any notable risk of flow of fluid given the proposed design

When charging quickly (e.g. in less than 5 minutes), it should be possible to dissipate a thermal power of e.g. 20 kW in a group of cells (a compartment in FIG. 2 or 8), instead of e.g. 2 kW in nominal use. This heat should be able to raise the temperature of the whole battery pack to a temperature level above the allowable temperature for normal operation of the pack. Devices such as PCM-loaded cells (or plates) could be used to dampen this temperature increase by, for example, 3 to 10° C. However, at the end of fast charging, a more efficient cooling system for the modules becomes a necessity:
via a lower temperature for the cooling flow of fluid F2 (which implies a change in the cooling setpoints and a loss of efficiency of the cooling producer), and/or
via an increase in the flow rate (which requires a variable flow pump and higher consumption) and/or
via an enlargement in the exchange surfaces.

Among the thermal interests of the peripheral, multi-sided, and in particular perimeter solution proposed by the invention, we can note:
a better homogenisation of the temperatures within the cell 7 when there is such a cooling,
an availability of important thermal exchange surface: it is possible to envisage exchange plates with a lower thermal conductivity (λ) than that of aluminium or stainless steel: composite, plastic, glass, with certainly a higher thermal resistance; but this can be compensated by a larger exchange surface and a higher convective exchange coefficient within the cooling path, including in particular if protrusions 26 are present.

In relation to flow of fluid F3, this is therefore a flow of fluid that can be made to maintain the temperature of compartment 9/cells 7 while the cells are not operating (not producing electricity). The circulation of the flow of fluid F3 can thermally recharge the PCM side plates 41a, 41b, if present.

In the solution shown in FIG. 15, the prismatic cells 7 of the battery 5 have lateral connection terminals 15, here marked 15a (anode) and 15b (cathode).

These connection terminals 15 are neither on the upper side 7a nor on the opposite lower side, but here on two opposite lateral faces 7c, 7d.

This means that the functionalised walls 11 of the housing 6 of the invention are lower (i.e. vertically) than the cells 7: H3<H4 FIG. 15.

By not extending to the level of these lateral connection terminals 15, the walls 11 and terminal blocks 31 will not interfere with the connection terminals 15, which will therefore overhang them, on the two longer opposite sides of the housing 6 in the example shown. This ensures that the electrical connections and the flow of the fluid(s) F1, F2 and/or F3 do not interfere.

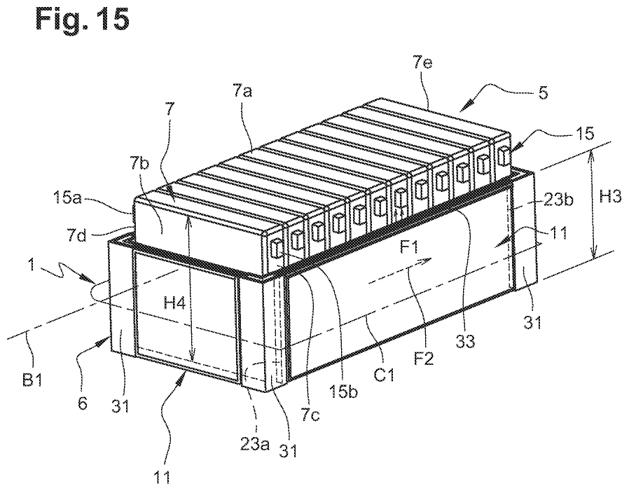

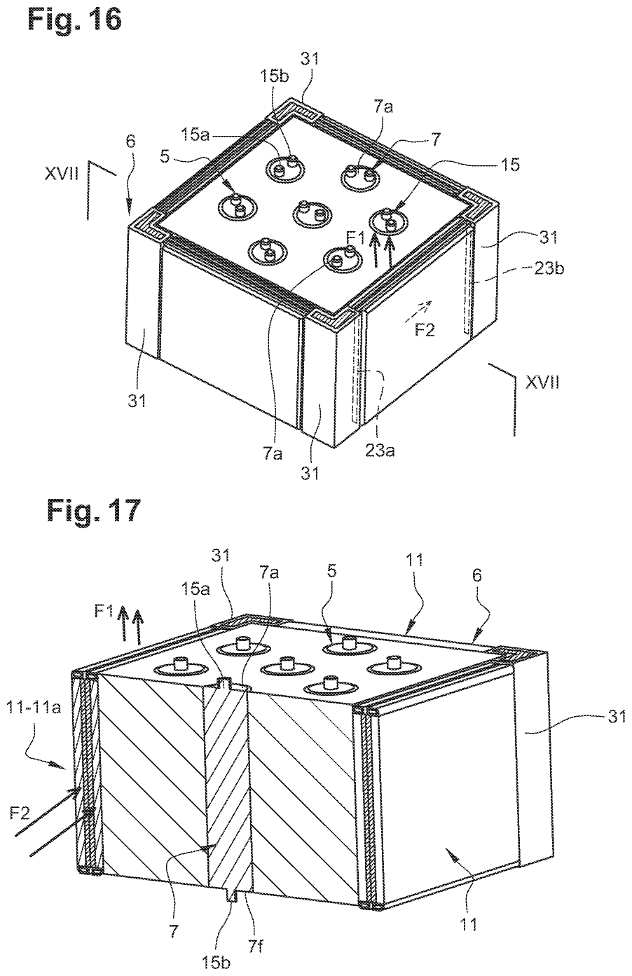

In FIG. 16, an example is shown where the cells 7 of the battery 5 are cylindrical and have upper connection terminals 15: The two terminals, here marked 15a (anode) and 15b (cathode), are on the top side 7a of each cell.

FIG. 17 shows an example where the cells 7 of the battery 5 are still cylindrical, but with connection terminals 15a and 15b, one on the upper side 7a, the other on the lower side 7f: Although the electrical connections between the cells and with the motor 3 are not illustrated, it is understood that the battery 5 is always, particularly in the two examples in FIGS. 16-17, in its functionalised housing 6.

The walls 11 and the terminal blocks 31 are located laterally to the opposite sides 7a, 7f of the cells, again not to interfere with the connection terminals 15.

In FIGS. 16-17, the said other flow of fluid F1 has been assumed to be statically present in the walls 11. The inlets and outlets of the flow of fluid F2 into and out of the housing 6 have not been illustrated.

On the other hand, in FIG. 16, an inlet 23a and an outlet 23b of the flow of fluid F2 circulating in one of the walls 11 has been illustrated. Internally, in each wall 11, the design can be as shown in FIG. 17, i.e. as in FIG. 3 or 7.

However, a solution tilted by 90° about a central axis A perpendicular to the plane P (FIG. 18) of the panel(s) 11, which can follow one another in a coplanar manner, as shown in FIG. 5 or 6, is possible.

In this case, as illustrated in FIGS. 18, 19 and 20:
the flow of fluid F1 will circulate “in series” and discharge from panel 11 to the adjacent panel 11 (arrows F1 FIG. 20), via the connecting blocks 31, while:
the flow of fluid F2 will circulate “in parallel” (each panel 11 has its outlet(s); arrow F2 FIG. 19).

If the walls 11 are upright, the flow of fluid F2 can flow from bottom to top or vice versa (the arrows would then be downwards in FIG. 18). In the same way, a “serial” flow of the fluid F1 can be obtained other than the example in FIG. 20.

In any case, it is expected to provide even better thermal management of the cells by keeping the flow of fluids (F1, F2) at a lower temperature for a longer period of time.

The above can of course be applied to the case of FIGS. 21-22 where the rolling vehicle concerned, of which a part of the horizontal chassis has been schematised, namely the (horizontal) bottom plate 35, comprises a housing 6 as previously presented (walls 11 on several sides with in particular flows F1 and F2, but with the particularity that one of the said walls of the housing (11-11a in the figure) which encloses at least one said space (17-17a1/17-17b1 in the figure) is oriented, on the vehicle, so as to be disposed parallel to the said chassis (to its bottom plate 35), facing it.

Thus, the contour C1 is in a vertical plane P2 and the axis(es) B1 of aligned arrangement of the cells, per row, is horizontal.

With the aid of this figure (considered only as a non-limiting example), it will be noted that, if in accordance with the invention, the housing 6 surrounds on several sides of this housing (and thus of the cells 7):
the said cells considered all together, or
the groups of cells 7 considered all together, it is possible that the walls 11 with hollow interiors (therefore with internal space(s) 11) allowing the fluids F1 and F2 to be present therein are organised as follows: one of these walls (marked 11-11e) is a bottom wall, situated in a plane parallel to the plane P2.

Thus, the functionalised walls 11 can extend in three perpendicular planes, these walls being adjacent to each other, so that one and/or the other of the fluids F1 and F2 can if necessary pass from one wall 11 to the adjacent wall 11.

In the solution of FIGS. 21 and 22, one can also note:
that each cell 7 has lateral sides of which two opposite lateral sides (including that 7e) define the largest surfaces of each cell 7, and
that the perimeter C1 extends perpendicularly to said largest surfaces of the cells considered together or of the groups (here of the two groups) of cells considered together.

This can lead to an efficient cell layout:
with their connection faces (terminals 15) arranged face to face, from one row to the next, parallel to the plane P2, the terminals 15 being oriented towards the centre of the housing where a free volume 55 allows the cables (not shown) for the electrical connections of the cells to each other and to the electric motor concerned to be placed, —and with their thin edges (sides of smaller surfaces 7a and 7f) elongated vertically.

A back-to-back orientation would have been less practical.

In a different way, in the solution of FIGS. 2, 13 and 15:
if each cell 7 always has lateral sides of which two opposite lateral sides (7b, 7e) define the largest surfaces of each cell,
the perimeter C1 passes around said largest surfaces of the cells considered all together or the groups of cells considered all together.

As already mentioned, both solutions are very efficient in terms of thermal efficiency, energy performance and/or compactness or space requirement.

In this respect, it can be noted that in both cases, each cell 7 therefore has lateral sides with, among these sides, two which are opposite lateral sides (7b, 7e) which define the larger surfaces of each cell parallel to which the cells are arranged in the housing, in one line (FIG. 15) or several lines (FIG. 2 or 13).

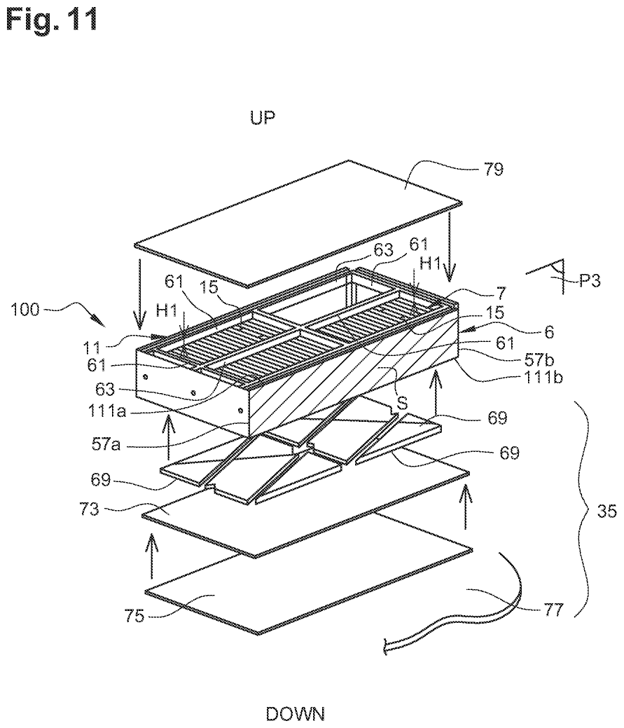

With regard to the walls 11 enclosing the said spaces (17; 17-17a1, 17-17a2; 17-17b1, 17-17b2 . . . ), the following should also be noted: these walls each have two thin, elongated, opposite edges (111a and 111b, FIG. 7), each of which extends:
either between two connectors 31 by which two said walls 11 are joined (as in FIG. 7),
or between two successive corners of the housing 6 (such as corners 57a and 57b in FIG. 11) which limit its sides.

In the latter case, the housing 6 could be a single piece (with walls 11 integrated together, for example moulded together, the bottom (11-11e FIG. 21) could also be integrated or attached with the other walls).

With this thin-edged wall 11 design such as 111a and 111b, the relevant walls 11 with interior spaces (17; 17-17a1, 17-17a2; 17-17b1, 17-17b2 . . . .) will each extend favourably in one plane (171 FIG. 3 and P3 FIG. 11):
perpendicular to the said thin edges, and
along which the wall has a surface S (see hatching FIG. 11 and perimeter in alternating long/short lines FIG. 3).

The surface S is delimited by said two thin edges 111a and 111b and:
either said two successive corners (such as 57a and 57b) of the housing,
or said two connectors 31.

In addition, the said spaces (17; 17-17a1, 17-17a2; 17-17b1, 17-17b2) of the walls of the housing occupy most of the surfaces (S) of these walls.

In other words, for an optimised efficiency in terms of thermal exchange performance, it is advisable that said spaces (17 . . . ) of the walls of the housing which define respective hollow interiors in these walls:
are so large that they occupy most at least of the interior of said walls, and
contain said flow of fluids (F1, F2), to adapt the temperature of said cells.

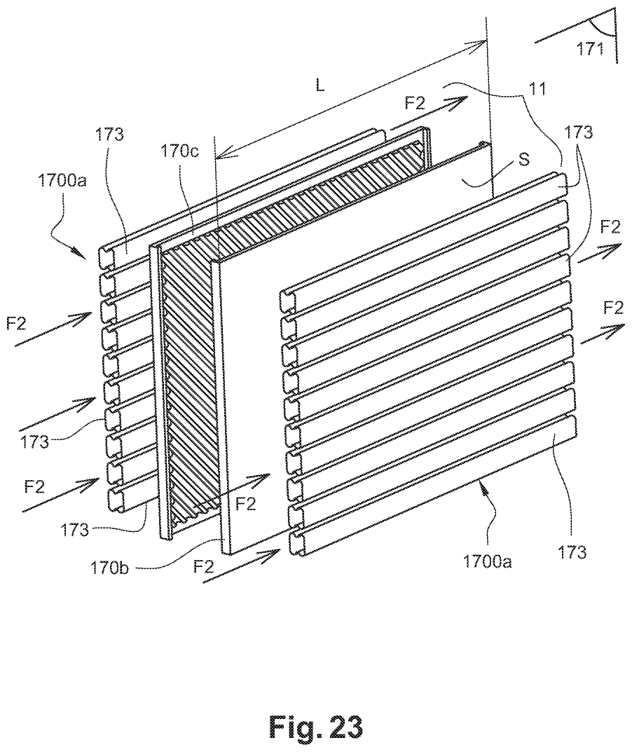

There is also another solution to consider. Two examples are illustrated in FIGS. 23 and 24. This solution is partly inspired by a networked realisation of at least one of the spaces 17. Indeed, in the solution with internal protrusions 26, these protrusions form a suitable network for the flow of fluid F1 or F2 to circulate in the corresponding space 17.

Thus, as a space 17 large enough to occupy most at least of the interior of said walls 11 (hence said surface zone S), there will not necessarily be a single space, but a networked or compartmentalised space.

In the solution shown in FIG. 23, one of the plates or panels defining the wall, in this case the outer plate or panel 170a, has been replaced by a series 1700a of tubes 173. It does not matter that in the example it is on the two opposite lateral faces of the panel 11 (two series 1700a).

If one is interested in one of these faces (or in each face considered in itself), the tubes 173 of a whole series (such as the one in the front FIG. 23) all together define a surface for the passage of the fluid F2 which is almost equivalent to the previous cases and which is as voluminous as the aforementioned one: the series of tubes 173 extends over almost the whole of the aforementioned surface S. All the tubes 173 are therefore hollow and extend along the aforementioned surface S; in this case along the entire length L of the remaining plates 170b, 170c between which a fluid F1 can be present, as before. Whether or not they are parallel to each other, all the tubes 173 of one (each) series will form a structure extending parallel to the aforementioned common plane 171 of the remaining wall plates.

If necessary, the ends of each tube 173 can be fluidly connected to the connectors 31 already shown, so that such a panel 11 can be connected to another adjacent identical panel 11.

The solution in FIG. 24 differs from that in FIG. 23 in that the three plates 170a, 170b, 170c of the first solution have been replaced by two adjacent series 1700a, 1700b, placed against each other in the plane 171.

Each series allows one of the fluids F2 (the outermost) and F1 (the innermost) to circulate and the series of tubes 173 occupies almost the equivalent of the whole of the aforementioned surface S.

Between the two most central 1700b series in the plane 171 extends the thermal insulating panel 29, to place this solution as a perfect alternative to that of FIG. 4, and equivalent to it in terms of performance of thermal exchange with the cells 7 standing in this case on either side, parallel to the plane 171.

The tubes 173 can be metallic, for example aluminium. But in fact, whether they are formed with plates, tubes or other materials, the hollow walls will be made of polymeric (plastic) or metallic material, or even composite, but a priori without PCM. As a polymeric material, interest has been shown in an elastomer. Examples of composites include organic matrix composites (OMC) and metal matrix composites (MMC). Metallic, the walls 11 would advantageously be thermally conductive with a conductivity λ greater than 1 W/mk, and even preferably greater than 5 or even 10 W/mk, in fact greater than the conductivity λ of PCMs that can otherwise be used in the housing 6.

If they extend opposite a flat plate of the housing (such as 170b or 170c in the solution in FIG. 23), they can be attached to it, for example by gluing or welding.

In the solution of FIG. 24 with two adjacent sets 1700a,1700b of tubes, the sets can also be attached together and to plate 29 in this case, to form a unitary assembly. If the tubes 173 in a series are vertical, they can have a closed bottom end 173a and contain a fluid F1 which will vaporise in due course if an adjacent cell overheats.

In a situation of a wall 11 with two fluids F1 and F2, either with two adjacent series 1700a1700b of tubes or with a wall 11 with two internal spaces (such as 17-17a1 and 17-17b1 and/or 17-17a2 and 17-17b2) parallel to each other in the plane of this wall (such as plane 171 FIG. 3), the flows of these two fluids F1 and F2 in the wall will preferably be crossed in relation to each other as shown in the drawings; but this is not strictly imperative: parallel flows could be provided (straight or angled, depending on the way the flanges (27a1,27a2,2b1 . . . ) on the plates 170a, 170b, 170c in a solution comparable to that of FIG. 4).

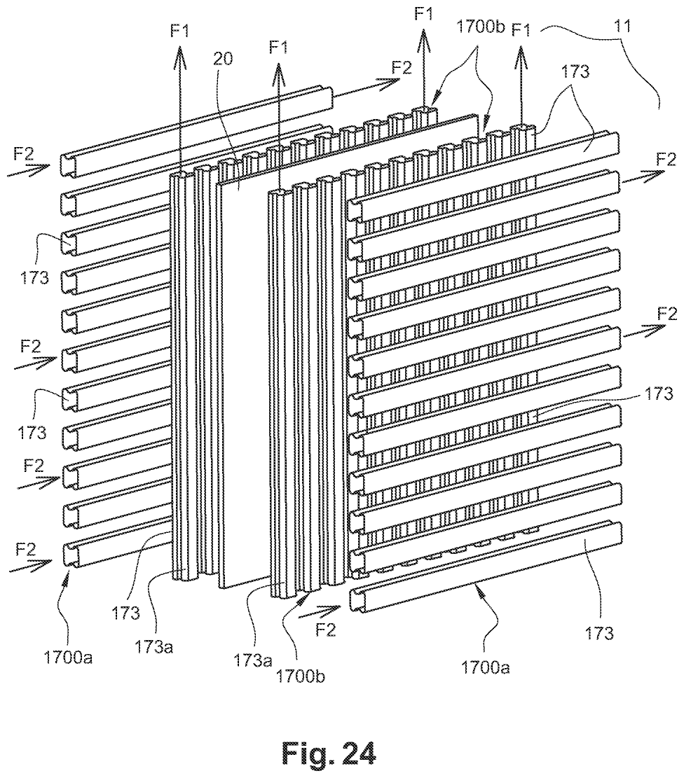

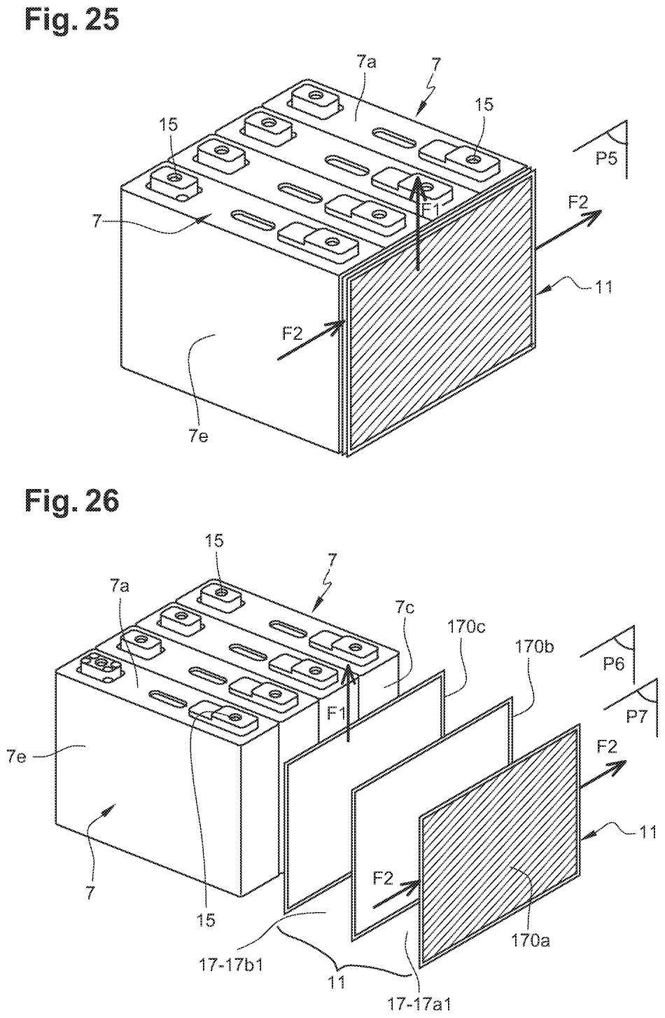

To further explain the specific features of the invention, reference can also be made to FIGS. 25 to 34 which, in pairs, show five possible situations, in connection with three different modes of implementation, shown in each case in the assembled situation, and with the wall 11 concerned moved away from the cell or cells 7 concerned, or even in exploded form (FIGS. 26, 28, 30, 32). The cells considered are prismatic.

In these five cases, there is a set comprising:
at least one cell 7 (in the example several cells aligned in a single row), said cell having several sides (such as 7a and 7e mentioned above), and
at least one wall 11 adapted to be in thermal exchange with the cell(s) and disposed for this purpose opposite them, in a plane P5 parallel to one of the sides (common between the cells if there are several of them) of the cell(s) 7, the wall 11 enclosing at least a first and a second space:
spaces 17-17a1, 17-17b1 in the example of the three-plate solution (FIGS. 25-28; see also FIG. 4 for details),
or a succession of internal passages 61 of the layer(s) of tubes 173.

The respective spaces extend in two planes:
parallel to each other (P6 and P7; but they can also be merged planes P8)
and parallel to said side of the cell or cells facing which said wall 11 extends: large side 7e or small side 7c on the figures.

In addition, the respective spaces:
are separated by at least one partition (the envelope 65 of any tube 173 or for example the intermediate plate 170b), so as not to communicate with each other, and
are adapted so that there are present, at the same time or at different times of operation of the cell(s), respectively the first flow of fluid (F2) and the second flow of fluid (F1), which therefore do not mix.

As already mentioned, it is clear from FIGS. 25 to 34 that said first and second spaces which define respective hollow interiors in said wall 11 are each so large that they occupy most at least of the interior of the wall 11 made.

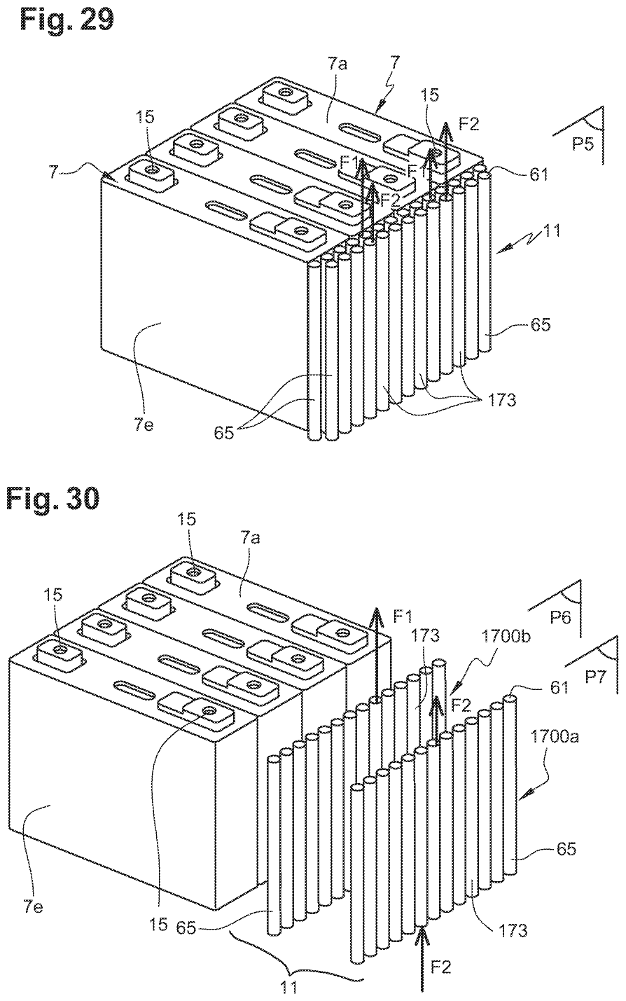

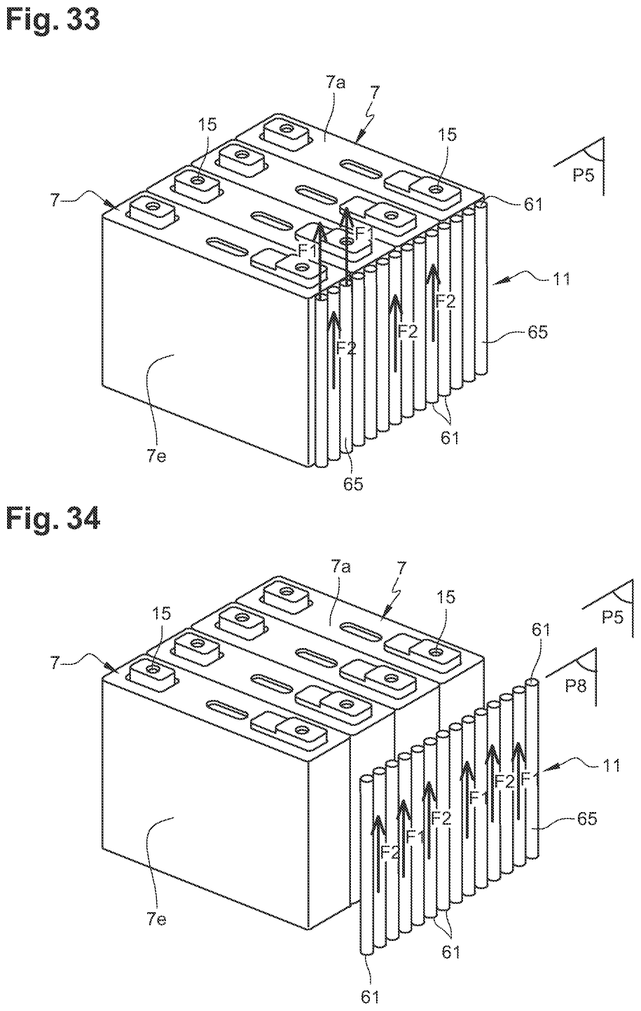

Again, with regard to the first and second spaces, it is further specified that:
the spaces 17-17a1, 17-17b1 in the example of the three-plate solution (FIGS. 25-28; see also FIG. 4 for details),
the succession of internal passages 61 (considered all together) of the respective layers of tubes 173 in the two-layer solutions of FIGS. 29-32, and
FIGS. 33-34, the internal passages 61 of the tubes 173, but here taking into account the alternation of tubes in two coplanar groups (plane P8): first group of tubes 173 for flow F1 and second group of other tubes 173 for flow F2. The 173 tubes are therefore in this case considered all together, but in groups. The tubes of one group are interspersed between one or more consecutive tubes of the other group.

In the first case (FIGS. 25, 26), the three parallel plates 170a, 170b, 170c of the solution in FIG. 4 are thus found arranged parallel to the same aligned short sides 7c of the cells. Flows F1 and F2 run in parallel and offset (planes P6, P7), as illustrated and as already explained.

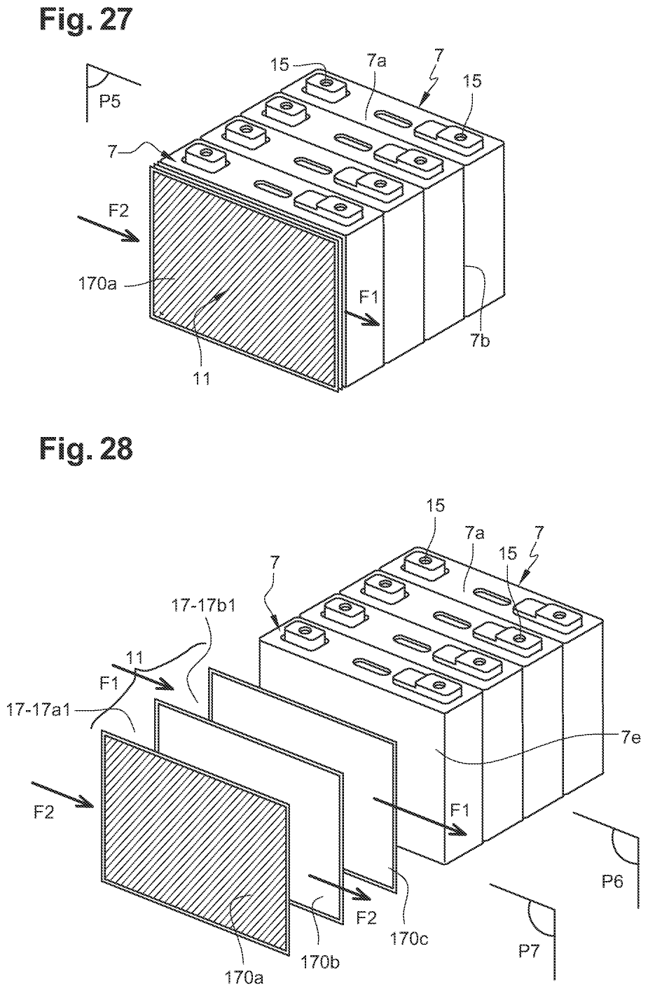

The second case (FIGS. 27, 28) is identical to the first case, except that the set of parallel plates 170a, 170b, 170c is now arranged opposite and adjacent to the same aligned long sides 7e of the cells.

Flows F1 and F2 run in parallel and offset (planes P6, P7), as illustrated and as already explained.

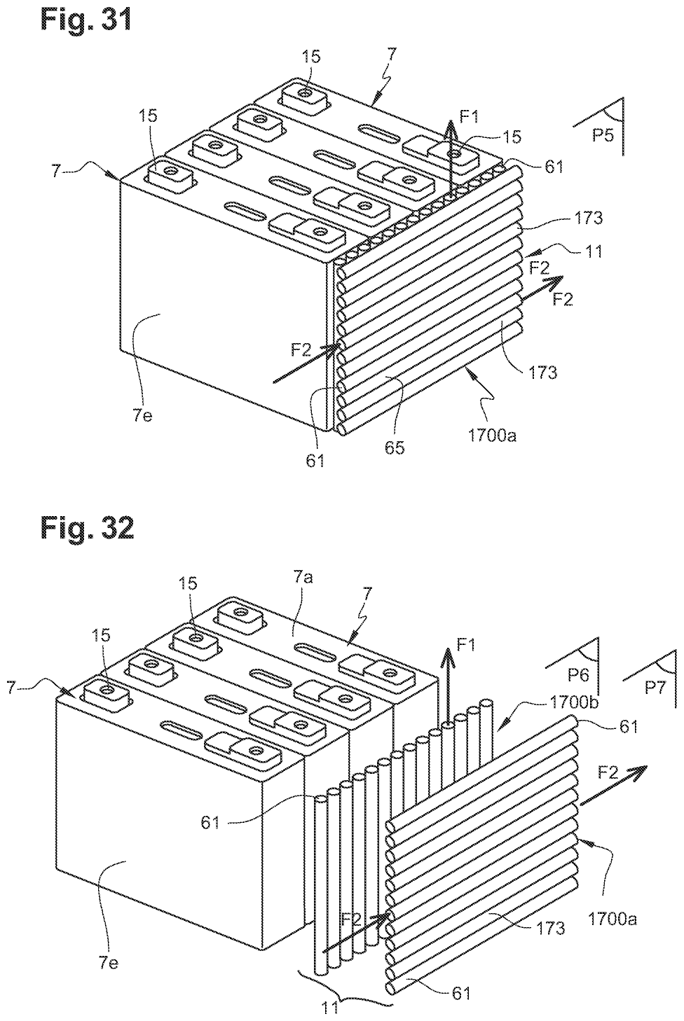

The third (FIGS. 29, 30) and fourth cases (FIGS. 31, 32) are identical, except that the tubes 173 of a layer 1700a and those of the other layer 1700b are:
parallel in the third case (FIGS. 29, 30) and
crossed (perpendicular in this case) in the fourth case (FIGS. 31, 32).

In the fifth case (FIGS. 33, 34), tubes 137 with envelope or wall 65 and openings 161 are found, but alternated in the same plane P8, along short sides of cells, even if this could be opposite at least a long side thereof, as well.

1.-15. (canceled)

16. An assembly comprising:
either at least one cell of an electric battery, said at least one cell having several sides, or a module having several sides and containing a group of cells and
at least one wall adapted to be in thermal exchange with said at least one cell or with the module and disposed for this purpose opposite it, in a plane parallel to one of the sides of said at least one cell or of the module, said at least one wall enclosing at least one space where at least one flow of fluid adapted to be in thermal exchange with at least one cell or with the module, for its thermal management, can be present,
characterized in that said at least one space comprises at least a first space for containing a first flow of fluid and at least a second space for containing a second flow of fluid:
which extend in two planes parallel to each other and to said side of said at least one cell or module facing or to which said wall extends,
which are separated by at least one partition, so as not to communicate with each other, wherein the first flow of fluid and the second flow of fluid are not mixed together.

17. The assembly of claim 16, wherein said at least one first space and at least one second space, which define respective hollow interiors in said at least one wall, are each so large as to occupy most at least of the interior of said at least one wall.

18. The assembly according to claim 16, wherein:
said at least one wall has a perimeter along an elongated thin edge,
said at least one wall extends in a plane perpendicular to said thin edge and along which the wall has a surface delimited by said perimeter,
and said at least one first space and at least one second space each occupy more than 50% of said surface.

19. The assembly according to claim 16, wherein:
said at least one first space and at least one second space are defined respectively between a first plate and a second plate and between the second plate and a third plate parallel to each other and joined together, the first, second and third plates have peripheral flanges, the first, second and third plates have peripheral flanges (27a1, 27a2, 2b1, 2b2) arranged to direct said flows, and/or—at least one of said at least one first space and at least one second space is defined by a series of tubes (173) arranged in the same plane or in parallel planes.

20. The assembly according to claim 16, wherein each of said at least one first space and at least one second space (17; 17-17b1, 17-17b2) is defined by tubes (173, 1700a, 1700b) arranged in at least a first and a second series located in the same plane or in parallel planes, the first series forming said at least one first space and the second series forming said at least one second space.

21. The assembly according to claim 16, which comprises:
several said cells or groups of said cells, and
a housing containing all of said cells, the housing peripherally comprising several sides and one or more of said walls per side, the housing surrounding on several sides:
said cells considered all together, or
the groups of cells considered all together.

22. The assembly according to claim 21, wherein:
the walls enclosing said spaces (17; 17-17a1, 17-17a2; 17-17b1, 17-17b2) have peripheral thin edges which extend individually:
either between two successive corners of the housing which limit its sides,
or between two connectors (31) by which two said walls are joined,
the walls which enclose said spaces (17; 17-17a1, 17-17a2; 17-17b1, 17-17b2) each extend in a plane perpendicular to said thin edge and along which the wall has a delimited surface, along said thin edge:
either between two successive corners of the housing,
or between two connectors, and
said spaces of the walls of the housing occupy most of the surface of said walls.

23. A vehicle comprising the assembly according to claim 16.

24. A vehicle that can be driven:
comprising at least one assembly according to any claim 16, with several of said cells connected with an electric motor; and
in at least one said wall which extends facing a said side of at least one said cell, said at least one first space and at least one second space contain, as said first flow of fluid and second flow, at the same time or at different times of operation of the cells, respectively a first flow of fluid, present to circulate in a nominal state of operation of the cells, and a second vaporizable flow, originating from the same or a different flow of fluid and adapted to be vaporized in said second space, in case of overheating of at least one said cell which then no longer operates nominally.

25. The vehicle according to claim 24 wherein, the cells having the nominal state in a first temperature range below a temperature threshold at which they overheat or deteriorate, said second flow of fluid which is contained in the second space of at least one said wall disposed adjacent to at least one cell which overheats is actually present in this second space:
either in the nominal state of the cells and during overheating or deterioration, or only during overheating or deterioration.

26. The vehicle according to claim 24 wherein, in the second space, said second flow of fluid is a flow of fluid capable, at ambient pressure, of changing phase.

27. The vehicle according to claim 24, wherein:
said second flow of fluid is present in the second space, in the overheated state of at least one said cell with which it is in thermal exchange, so that at a temperature threshold of said at least one cell said second flow of fluid reaches its vaporization temperature, and
the second space is open, to allow evacuation of said second flow of fluid vaporized out of said wall, to the external atmosphere.

28. The vehicle according to claim 24 wherein, for said circulating presence of the first flow of fluid:
the first space communicates, in the wall containing it, with a flow of fluid inlet and outlet, and
the vehicle further comprises a recycling circuit for recycling said fluid from the outlet to the inlet and on which are disposed means for the forced circulation of the fluid and an exchanger for heat exchange between the first flow of fluid and another flow of fluid.

29. The vehicle according to claim 24 which comprises the assembly according to claim 6, and wherein:
the cells are distributed in the housing in several groups of cells, at least one of said walls extends between two groups of cells, as an internal partition of the housing, and
at least one of said at least one first space and at least one second space of said internal partition communicates with respective ones of said other walls of the housing, so that at least one of said first flow of fluid and second flow of fluid circulates, at a given time, from one space to another space of a said other wall.

30. A method of thermally managing at least one cell of an electric battery by means of at least one wall adapted to be in heat exchange with said cell, said wall enclosing at least one space where at least one flow of fluid (F1, F2) adapted to be in heat exchange with at least one cell can be present, for its thermal management,
characterized in that, since said at least one space comprises at least one first space and at least one second space arranged parallel to each other:
at least while the said cell is operating nominally, a first flow of fluid is caused to circulate in the said first space, and,
at least in a situation of overheating of the said cell, which is then no longer operating nominally, a second vaporizable flow, originating from the same flow of fluid or from a different flow of fluid and then contained in the said second space, is caused to vaporize out of the said second space, by heat transfer from the cell to the said wall.

31. A method of thermally managing, by means of an assembly, a cell of an electric battery or a module comprising a plurality of cells of an electric battery, said cell or module being adapted to operate at predetermined temperatures, the assembly comprising at least one wall adapted to be in heat exchange with said cell or said module,
said wall enclosing at least one space where a flow of fluid adapted to be in heat exchange with said cell or said module can be present, for the thermal management, said cell or said module having several sides,
said at least one wall being disposed opposite said cell or said module, in a plane parallel to one of said sides thereof,
said at least one wall enclosing at one space where a flow of fluid, adapted to be in thermal exchange with said cell or with the module, can be present,
wherein said at least one space comprises a first space and a second space:
which extend in two planes parallel to each other and to said side of said cell or said module facing or to which said at least one wall extends, and
which are separated by a partition, so as not to fluidically communicate with each other, and
wherein said flow of fluid comprises a first flow of fluid and a second flow of fluid which are not mixing together and which flow, at a same time or at different times of operation of said cell or module, respectively in said first space and said second space.
